(19) United States
(12) Patent Application Publication
(10) Pub. No.: US 2010/0131284 A1
(43) Pub. Date: May 27, 2010

(54) METHODS AND APPARATUS FOR ANALYSIS OF HEALTHCARE MARKETS

(76) Inventor: Michael Day Duffy, Glenview, IL (US)

Correspondence Address: Hanley, Flight & Zimmerman, LLC, 150 S. Wacker Dr. Suite 2100, Chicago, IL, 60606, US

(21) Appl. No.: 12/357,486

(22) Filed: Jan. 22, 2009

Related U.S. Application Data
(60) Provisional application No. 61/118,163, filed on Nov. 26, 2008.

(51) Int. Cl. G06Q 50/00; G06Q 10/00

(52) U.S. Cl. 705/2; 705/10

(57) ABSTRACT

Methods and apparatus for identifying a market opportunity for a healthcare product are disclosed. A disclosed example computer implemented method comprises obtaining a first data set containing market demand information relating to at least the healthcare product, obtaining a second data set containing market availability information relating to at least the healthcare product, obtaining a third data set containing market consumption information relating to at least the healthcare product, comparing data from at least two of the first, second and third data sets to identify a market opportunity for the healthcare product, and outputting the identified market opportunity to a user.

### RELATED APPLICATIONS

This patent claims the benefit of U.S. provisional application Ser. No. 61/118,163, filed on Nov. 26, 2008, which is hereby incorporated by reference herein in its entirety.

### FIELD OF THE DISCLOSURE

The present disclosure relates generally to market research and, more particularly, to methods and apparatus for analysis of healthcare markets.

### BACKGROUND

Market research companies have developed numerous techniques to measure consumer behavior, retailer/wholesaler characteristics, and/or marketplace demands. For example, ACNielsen® has long marketed consumer behavior data collected under its Homescan® system. The Homescan® system employs a panelist based methodology to measure consumer behavior and identify sales trends. In the Homescan® system, households, which are statistically representative of the demographic composition of a population to be measured, are retained as panelists. These panelists are provided with scanning equipment and agree to use that equipment to identify and/or otherwise scan the Universal Product Code (UPC) of every product they purchase and to note the identity of the retailer or wholesaler (collectively or individually “merchant”) from which the corresponding purchase was made. The data collected via this scanning process is periodically exported to ACNielsen®, where it is compiled into one or more databases. The data in the databases is analyzed using one or more statistical techniques and methodologies to create reports of interest to manufacturers, retailers/wholesalers, and/or other business entities. These reports provide business entities with insight into one or more trends in consumer purchasing behavior with respect to products available in the marketplace.

Market research companies also monitor and/or analyze marketplace demands and demographic information related to one or more products in different geographic boundaries. For example, ACNielsen® has long compiled reliable marketing research demographic data and market segmentation data via its Claritas™ and Spectra® services. These services provide this data related to, for example, geographic regions of interest and, thus, enable a customer to, for instance, determine optimum site locations and/or customer advertisement targeting based on, in part, demographics of a particular region. For example, southern demographic indicators may suggest that barbecue sauce sells particularly well during the winter months while similar products do not sell as well in northern markets until the summer months.

Market research companies also monitor and/or analyze point of sale data with respect to one or more merchants in different market segments. For example, ACNielsen® has long compiled data via its Scantrack® system. In the Scantrack® system, merchants install equipment at the point of sale that records the UPC code of every sold product, the quantity sold, the sale price, and the date that the sale occurred. The point of sale (POS) data collected at the one or more stores is periodically exported to ACNielsen® where it is compiled into one or more databases. The POS data in the databases is analyzed using one or more statistical techniques and/or methodologies to create reports of interest to manufacturers, wholesalers, retailers, and/or other business entities. These reports provide insight to manufacturers and/or merchants into one or more sales trends associated with products available in the marketplace. For example, the reports reflect the sales volumes of one or more products at one or more merchants.

Market research companies may also provide market research information focused on specialized markets. Wolters Kluwer Health developed the Source® brand products to provide information that enables healthcare product manufacturers to design marketing and sales strategies for a healthcare product. To provide the market research information, the Source® products gather information related to healthcare providers (e.g., a location, a recommendation, a prescribing history, etc.), healthcare consumers (e.g., a treatment history, a claim, a payment, etc.), products (e.g., a dispensing location, a price, a prescription, etc.) and payors (e.g., a claim, an affiliation, etc.). For example, Wolters Kluwer Health surveys healthcare providers for their recommendations for over-the-counter (OTC) products and provides the information via Source® Consumers Product Group to assist in identifying marketing opportunities or providing a basis for marketing claims. Another product, Source® Dynamic Claims, provides data associated with actual copay amounts paid at pharmacies by healthcare consumers. This data then is analyzed to provide market information for a healthcare product over a particular region such as, for example, identifying the payors with the most market share within a region.

### BRIEF DESCRIPTION OF THE DRAWINGS

FIG. 1 depicts an example consumer healthcare market.

FIG. 2 is a block diagram depicting an example market analysis system for analyzing the consumer healthcare market illustrated in FIG. 1.

FIG. 3 is a block diagram representation of an example healthcare market analyzer implemented in the example market analysis system of FIG. 2.

FIG. 4 is a block diagram representation of an example data set generator implemented in the example healthcare market analyzer of FIG. 3.

FIG. 5 is a block diagram representation of the example availability analyzer implemented in the example data set generator of FIG. 4.

FIG. 6 is an illustration of an example matrix containing market availability data determined by the availability analyzer depicted in FIGS. 4 and 5.

FIG. 7 is a block diagram representation of the example demand analyzer implemented in the example data set determiner of FIG. 4.

FIG. 8 is a block diagram representation of the example consumption analyzer implemented in the example data set determiner of FIG. 4.

FIG. 9 is a block diagram representation of the example market opportunity identifier implemented in the example healthcare market analyzer of FIG. 3.

FIG. 10 is an illustration of example market opportunities that may be identified by the example market opportunity identifier of FIGS. 3 and 9.

FIG. 11 is a flow diagram representative of an example process that may be performed to implement the market analyzer illustrated in FIGS. 2-9.

FIG. 12 is a flow diagram flow diagram representative of an example process that may be performed to implement the demand analyzer of FIGS. 4-7.

FIG. 13 is a flow diagram flow diagram representative an example process that may be performed to implement the availability analyzer of FIGS. 4 and 5.

FIG. 14 is a flow diagram flow diagram representative of an example process that may be performed to implement the consumption analyzer of FIGS. 4 and 8.

FIG. 15 is a flow diagram flow diagram representative of an example process that may be performed to implement the market opportunity identifier of FIGS. 3 and 9.

FIGS. 16A-16B are representations of example drug index data available from the market availability data set.

FIGS. 17A-17C are representations of example provider and payor data available from the market availability data set.

FIG. 18 is a representation of example price and cost data for a healthcare product available from the market availability data set.

FIG. 19 is a representation of an example of a disease prevalence distribution map.

FIG. 20 is a representation of a map depicting an example illustrating mortality rates due to a disease.

FIG. 21 is a representation of an example utilization ratio distribution illustrating a market opportunity for a healthcare product.

FIG. 22 is a representation of example access restrictions of a healthcare product in terms of prescriptions lost.

FIG. 23 is a block diagram of an example processor system that may be used to implement the methods and/or apparatus described herein.

### DETAILED DESCRIPTION

Certain examples are shown in the above-identified figures and described in detail below. In describing these examples, like or identical reference numbers may be used to identify common or similar elements. Although the example systems described herein include, among other components, software executed on hardware, such apparatus is merely illustrative and should not be considered as limiting. Any or all of the disclosed components could be embodied exclusively in hardware, exclusively in software, exclusively in firmware or in some combination of hardware, firmware or software.

Product manufacturers turn to market research companies to gain insight into consumer purchasing behavior and market trends to improve the performance of their brands in the marketplace. Pharmaceutical companies and other manufacturers of healthcare products are no different in that respect, but face some special challenges because healthcare products are often marketed simultaneously to distinct, but interrelated groups such as healthcare providers, payors (e.g., health insurers), retailers, and healthcare consumers. Each of these groups presents particular challenges to the efforts of healthcare product manufacturers to maximize the return on their marketing investment.

Consumer medical conditions and the resulting or corresponding healthcare needs drive the demand for a product in the healthcare market, but the price and availability of healthcare products contribute greatly to the choices made by consumers. Further, the complex relationships among healthcare consumers, medical providers, payors and retailers influence the pricing and availability of a healthcare product and may vary greatly between geographic locations. Therefore, for healthcare product manufacturers to maximize their return on marketing investments, the manufacturers need information providing insight into a demand for a healthcare product, a consumer's access to the healthcare product and a consumer consumption pattern of the healthcare product for geographic areas of interest, as well as the manner in which such different types of information interrelate.

Generally, the example methods and apparatus described herein may be used to identify a market opportunity (e.g., a formulary development strategy, a return on investment strategy, a communication strategy, a healthcare market identification strategy, etc.) for a healthcare product by analyzing data compiled into at least one of a market demand data set (e.g., a likelihood of diagnosis of a healthcare need), a market availability data set (e.g., a provider affiliation estimated from claims data), or a market consumption data set (e.g., a predicted or actual use of a healthcare product) for a geographic location or a consumer segment.

More specifically, the example methods and apparatus described herein obtain the market availability data set corresponding to the healthcare consumer, the healthcare provider, the retailer, the payor and/or the government organization via (1) data collected from a plurality of sources (e.g., a consumer panel, a healthcare claims data set, a market research demographics data set and/or a government statistics data set) and (2) characteristics estimated from the collected data. The estimated characteristics include a provider characteristic (e.g., an affiliation characteristic based on claims data or a coverage characteristic based on formulary data) and a payor characteristic (e.g., a coverage characteristic based on dispensing records). Further, the payor characteristic and the dispensing records are analyzed to link at least two of a provider, a payor, a retailer or a prescription.

The example methods and apparatus described herein also obtain the market demand data set corresponding to the healthcare consumer, the healthcare provider, the retailer, the payor and/or the government organization via (1) data collected from the plurality of sources (e.g., a consumer panel, a healthcare claims data set, a market research demographics data set and/or a government statistics data set) and (2) an estimated healthcare need characteristic (e.g., a likelihood of a healthcare need). Further, the estimated healthcare need characteristic is linked to at least one of a provider, a retailer or payor for a geographic area.

Additionally, the example methods and apparatus described herein obtain the market consumption data set corresponding to the healthcare consumer, the healthcare provider, the retailer, the payor and/or the government organization via (1) the data collected from the plurality of sources (e.g., a consumer panel, a healthcare claims data set, a market research demographics data set and/or a government statistics data set) and (2) estimated characteristics associated with patient use and market performance of a healthcare product. The patient usage characteristic is then linked to the market performance of the healthcare product, a provider, a payor and/or a retailer for a geographic location. Further, the patient usage characteristic is used to predict a healthcare product utilization characteristic upon a population represented by a panel of consumers (e.g., the Homescan® panelists). The predicted characteristic is then used to project the utilization characteristic upon a larger population (e.g., the population of a county, state, country, etc.).

In one example implementation, a healthcare market analyzer collects data related to the healthcare market from a plurality of sources (e.g., a market research product such as Homescan®, Claritas™, Spectra®, Source®, and/or government records) and determines an example market availability data set, an example market demand data set and an example market consumption data set. An example market opportunity identifier then identifies market opportunities to increase the return on investment of marketing efforts for a healthcare product and outputs the identified market opportunity to a user. The example healthcare market analyzer obtains a healthcare data set from data collected via the market research products mentioned above. The example healthcare data set is then analyzed by a demand analyzer, an availability analyzer and/or a consumption analyzer to determine at least one of the market demand data set, the market availability data set or the market consumption data set, respectively.

In determining the market availability data set, an availability analyzer of the example implementation analyzes the healthcare data set to estimate at least one of payor characteristics and/or provider characteristics. The provider characteristics are estimated from claims data and/or formulary data. The payor characteristic is estimated from dispensing records and is used to link a provider to a prescription, a prescription to a retail dispensing location, and/or the retail dispensing location to a payor. A compiler then compiles the estimated characteristics, the linked data and the healthcare data set into the market availability data set.

The demand analyzer of the example implementation estimates a healthcare need characteristic (e.g., a likelihood of a specific healthcare need) based on a healthcare prevalence metric and a healthcare consumer metric from the healthcare data set (e.g., a demographics metric, an economic metric, an ethnicity metric, a lifestyle metric, a spending metric, a media consumption metric, etc.) for a geographic location and/or a consumer segment. A linker links the healthcare need characteristic with a provider characteristic, retailer characteristic, and/or a payor characteristic over the geographic area. A compiler then compiles the estimated healthcare need characteristic, the linked characteristic(s) and/or the healthcare data set into a market demand data set.

The consumption analyzer of the example implementation first collects a sufferer panel data set related to the characteristics of persons with a healthcare need and/or using a healthcare product. Alternatively or additionally, the consumption analyzer may derive similar characteristics based on data collected from panelist data within the healthcare data set. The consumption analyzer next determines a characteristic related to the use of the healthcare product (e.g., a patient usage characteristic or a market performance characteristic) from prescription claims data and/or OTC sales data. The patient usage characteristic is linked by a linker to at least one of the market performance characteristic, a provider characteristic, a retailer characteristic and/or a payor characteristic for a geographic location. Additionally, a predictor predicts a behavior characteristic from an analysis of a consumer panel characteristic and/or a sufferer panel characteristic. A projector projects the predicted characteristic to the population defined by a geographic area (e.g., a zip code, a health service area, a state, etc.). A generator then generates a market consumption data set from the healthcare data set, the determined characteristics, the predicted behavior characteristic and the projected behavior characteristic.

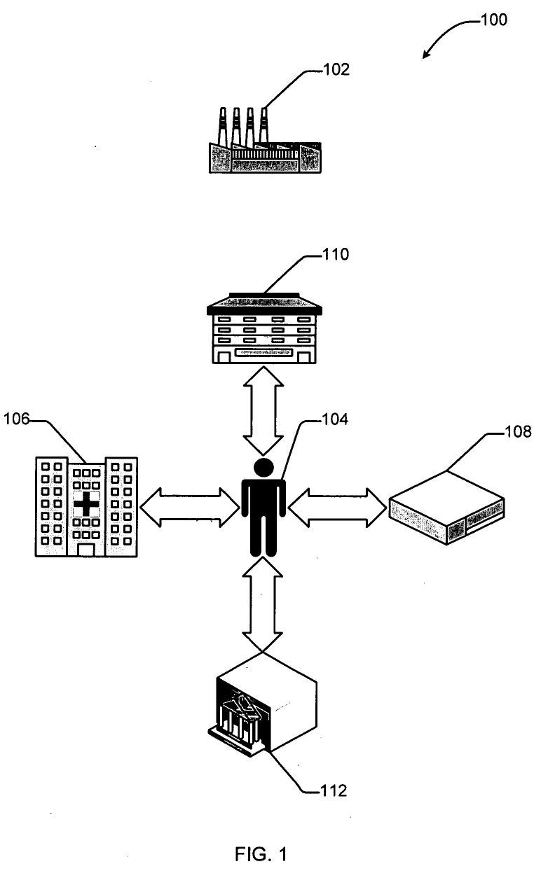

FIG. 1 depicts an example representation of a healthcare market 100 (e.g., a market for a healthcare product) of interest to a healthcare product manufacturer 102. The example healthcare market 100 includes a population of healthcare consumers represented by a healthcare consumer 104, a medical provider 106 (e.g., a doctor, a dentist, etc.), a retailer 108 (e.g., a pharmacy, a grocery store, etc.), a payor 110 (e.g., an insurance company) and/or a government organization 112 (e.g., the Centers for Medicare and Medicaid services, The Centers for Disease Control, etc.). A healthcare consumer 104 faces many choices in making healthcare decisions that further involve decisions made by the providers 106, the payors 110 and the retailers 108. Therefore, manufacturers of healthcare products 102 turn to market research corporations to provide insight into market-by-market segmentation.

Generally, the market 100 for the healthcare product corresponds to a healthcare need (e.g., a medical condition) of healthcare consumers 104, a treatment prescribed or recommended by the healthcare provider 106, a cost for the treatment defined by the payor 110 or government organization 112 and/or an availability of the healthcare product at the retailer 108. More specifically, healthcare needs and treatment opportunities vary between geographic locations due to differences in the healthcare needs of local populations and the individual relationships between the consumers 104, the providers 106, the retailers 108, the payors 110 and/or the government organizations 112 within the geographic areas. Price and availability contribute greatly to the purchasing decisions of the healthcare consumers 104. For example, the healthcare consumer 104 may decline to purchase a healthcare product if the cost is too high and/or the healthcare product is not locally available. Further, the availability of the healthcare product depends on recommendations and/or prescriptions for the product by the provider 106, the inclusion of the healthcare product on a formulary list, and/or the healthcare product being offered for sale by the retailer 108.

The relationship between the healthcare consumer 104 and the payor 110 depends on a number of factors such as the healthcare consumer 104 (1) may not be insured, (2) may have a choice of health insurance plans from one or more payors 110 (e.g., an employment health insurance benefit or a privately purchased health plan) or (3) may be eligible for a medical program offered through a government organization 112 (e.g., Medicare and/or Medicaid). Additionally, other factors affecting choices of the healthcare consumer 104 include the monthly cost of the healthcare plan, the healthcare providers 106 within the healthcare plan network, and/or the copay costs associated with treatment.

Similarly, a number of factors affect the relationship between the healthcare consumer 104, the healthcare provider 106 and/or the retailer 108. For example, the healthcare consumer 104 may choose to seek treatment from a healthcare provider 106 or choose an OTC treatment purchased from the retailer 108 for their symptoms. The healthcare consumer 104 may choose a retailer 108 in the same geographic area, an online retailer 108, and/or through a mail-order option offered through a healthcare plan. If the healthcare consumer 104 chooses an OTC product, the healthcare consumer 104 may choose the OTC product based on recommendations, research about competing products, advertising and/or price.

Additionally or alternatively, the healthcare consumer 104 may seek treatment from the healthcare provider 106. Depending on the healthcare need, the healthcare provider 106 may have a variety of healthcare products to prescribe or recommend to the healthcare consumer 104. The healthcare provider 106 may base the recommendation on the effectiveness of a healthcare product to treat a particular healthcare need, personal preference for particular healthcare products, and/or knowledge of the products included on the formulary of the payor 110 utilized by the healthcare consumer 104.

If the healthcare provider 106 prescribes a healthcare product, the healthcare consumer 104 may still not purchase that particular product. For example, a healthcare consumer 104 may choose to not fill a prescription for a variety of reasons including the cessation of symptoms, the price associated with the prescription (e.g., because the prescribed product is not included on the payor 110 formulary) and/or because the healthcare consumer 104 does not have healthcare coverage for prescription products. Further, the retailer 108 may not offer the healthcare product due to an agreement with a pharmacy benefit manager to substitute a generic or competing product.

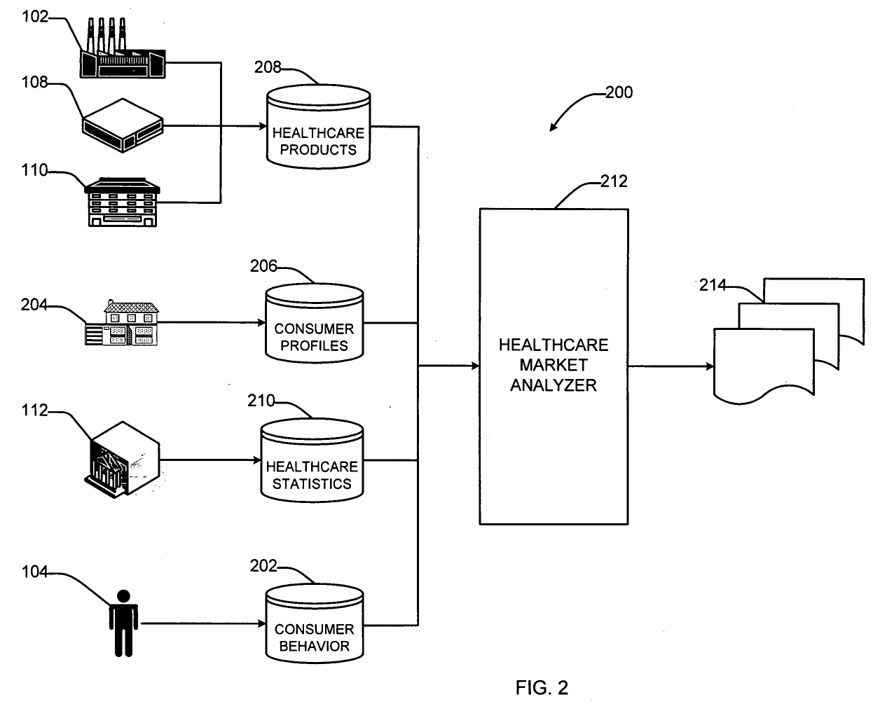

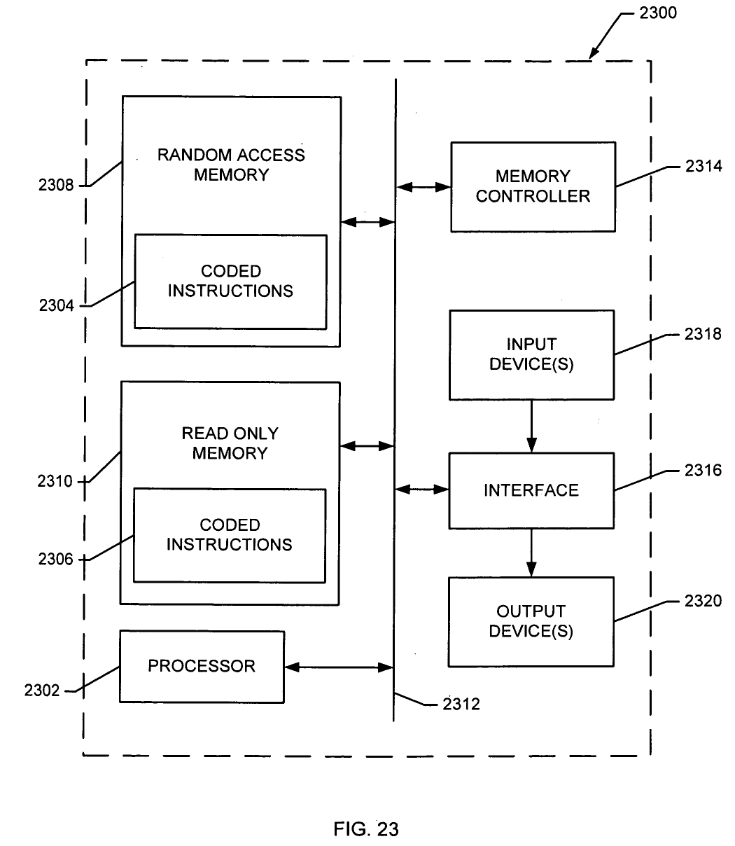

FIG. 2 is an example representation of a market analysis system 200 that may be used by a market research company to analyze the consumer healthcare market 100 of FIG. 1. The example system 200 includes a consumer behavior data set 202, a consumer profiles data set 206, a healthcare products data set 208, a healthcare statistics data set 210, a healthcare market analyzer 212 and an identified market opportunity or opportunities 214. The data stored in the consumer behavior data set 202, the consumer profiles data set 206, the healthcare products data set 208, and the healthcare statistics data set 210 may be stored in any format (e.g., an American Standard Code for Information Interchange (ASCII) format, a binary format, etc.) for storing data on an electronic medium (e.g., a memory or a mass storage device). The electronic medium may be a non-volatile memory (e.g., flash memory), a mass storage device (e.g., a disk drive), a volatile memory (e.g., static or dynamic random access memory) and/or any combination of the memory types. For example, the consumer behavior data set 202 may be stored in binary format on a random access memory 2308 (FIG. 23) communicatively coupled to a processor 2302 within a processor system 2300, such as a processor system 2300 described in detail below in conjunction with FIG. 23.

Generally, a market research company may use the healthcare market analyzer 212 to analyze the healthcare market 100 discussed in conjunction with FIG. 1. The consumer behavior data set 202 is collected from healthcare consumers 104 via, for example, UPC scanning equipment and contains data associated with purchases made by the consumer 104 and includes data such as a purchase price and/or a purchase location. The consumer profiles data set 206 is collected from participating households 204 via, for example, surveys and may contain, for example, consumer demographic information and/or market segmentation information arranged by geographic location. The healthcare products data set 208 may be collected from healthcare product manufacturers 102, healthcare providers 106, retailers 108 and/or payors 110 and may contain data corresponding to the use of healthcare products in the healthcare market 100. For example, the healthcare products data set 208 may contain information corresponding to healthcare claims submitted to a payor 110 from healthcare providers 106 and/or retailers 108, corresponding to sales of healthcare products at retailers 108 including over the counter sales and/or prescription sales. The healthcare statistics data set 210 is collected from governmental agencies 112 and may contain statistical information corresponding to, for example, the health status of a population (e.g., residents of a state) or subgroup of a population (e.g., residents of a state over the age of 65). The healthcare market analyzer 212 is then used by the market research company to identify the market opportunities 214 based on information from one or more of the above-mentioned data sets 202, 206, 208, and 210.

For example, ACNielsen® has long collected consumer behavior data via its Homescan® system from panelists retained to be representatives of a population. Data of this type is stored for analysis in accessible data sets, such as the example consumer behavior data set 202. Additionally, ACNielsen® has also collected demographic and market segmentation data via its Claritas™ and Spectra® services. These services store collected demographic and segmentation data for use in creating consumer profiles, such as the example consumer profiles data set 206. Other market research companies collect market information targeting specific markets, such as the Source® products from Wolters Kluwer Health that collect information associated with the healthcare market as stored in the example healthcare products data set 206. Government organizations 112 (e.g., the National Center for Disease Statistics) collect statistical data associated with the health and welfare of citizens (e.g., mortality rates from specific health conditions, disease prevalence, etc.) and provide that information to the public via the example healthcare statistics data set 210.

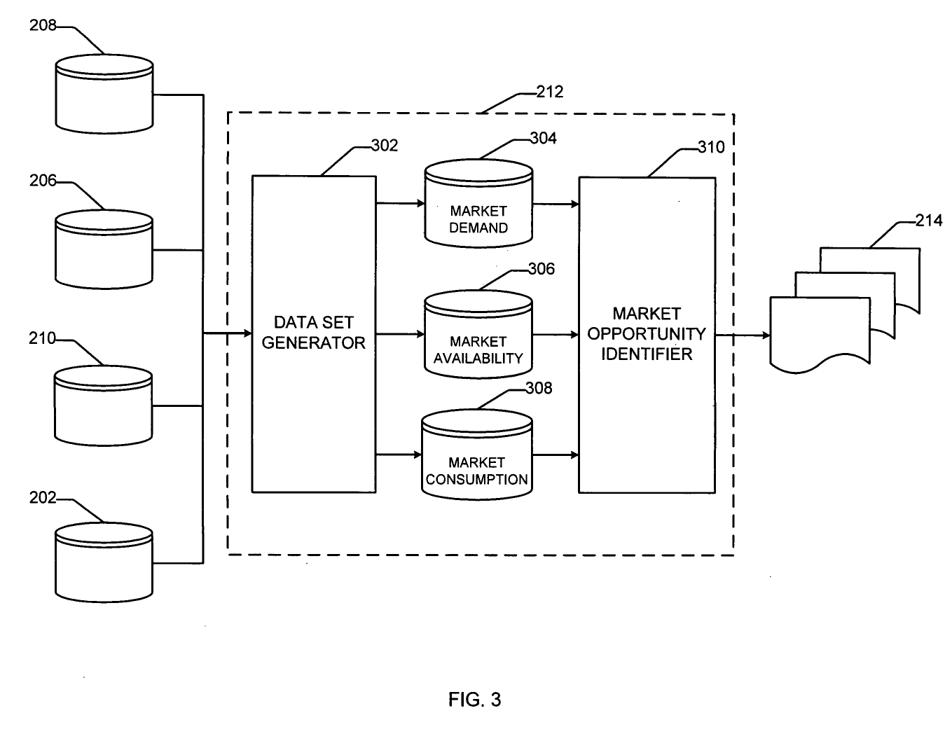

The example healthcare market analyzer 212 is configured to analyze the data provided from market research corporations via the consumer behavior data set 202, the consumer profiles data set 206, the healthcare products data set 208 and the healthcare statistics data set 210 to determine the marketing opportunities 214, which may be used by healthcare product manufactures 102 to focus marketing efforts for one or more healthcare products. The example healthcare market analyzer 212 analyzes the data sets 202, 206, 208, and/or 210 to identify a healthcare need associated with a healthcare product, calculate an availability of the healthcare product and determine a consumption behavior for consumers of the healthcare product as described in more detail below in conjunction with FIGS. 3-15. The market research company may then provide the identified marketing opportunities 214 (e.g., a location of a potential healthcare market, a formulary development strategy, a product success forecast, etc.) to healthcare product manufacturers 102 in any manner and/or type of video, audio and/or print format to facilitate a marketing effort for the healthcare product.

FIG. 3 depicts a block diagram of an example implementation of the healthcare market analyzer 212 of FIG. 2. The example healthcare market analyzer 212 includes a data set generator 302, a market demand data set 304, a market availability data set 306, a market consumption data set 308 and a market opportunity identifier 310. The example data set generator 302 first analyzes data provided by market research companies via the consumer behavior data set 202, the consumer profiles data set 206, the healthcare products data set 208 and the healthcare statistics data set 210 to determine market segmentation data (e.g., a market demand, a market availability, and/or a market consumption pattern) corresponding to the use of healthcare products within the healthcare market 100 by healthcare consumers 104. The data stored in the market demand data set 304, the market availability data set 306, and/or the market consumption data set 308 may be stored in any format similar to those discussed above in conjunction with the example data sets 202 and 206-210 of FIG. 2.

The data set generator 302 generates the market demand data set 304 by analyzing data from the plurality of sources (e.g., the consumer behavior data set 202, the consumer profiles data set 206, the healthcare products data set 208, and/or the healthcare statistics data set 210) with an estimated healthcare need characteristic (e.g., a likelihood of a healthcare need for a consumer demographic). The market demand data set 304 defines the healthcare market 100 in terms of consumer characteristics, (e.g., demographics, geographic location, treatment preferences, and/or media consumption history) and/or a likelihood of a healthcare need by location and/or consumer segment. Further, the data set generator 302 generates the market availability data set 306 by analyzing the consumer behavior data set 202, the consumer profiles data set 206, the healthcare products data set 208 and/or the healthcare statistics data set 210, estimating provider and/or payor characteristics (e.g., a provider affiliation characteristic, a provider coverage characteristic and/or a payor coverage characteristic), and integrating the analyzed data and the estimates into a data set organized by geographic location and/or consumer demographics. The market availability data set 306 defines the healthcare market 100 in terms of a healthcare consumer's access to healthcare in terms of price across provider affiliations and payor formularies for a geographic area (e.g., a health service area, a manufacturer sales area and/or a zip code) or a specific consumer group (e.g., a subscriber employee territory or a demographic segment). Additionally, the data set generator 302 generates the market consumption data set 308 to define the healthcare market 100 in terms of healthcare product utilization by examining actual healthcare consumer consumption patterns through aggregate retailer sales data and individual prescriptions.

The market opportunity identifier 310 identifies marketing opportunities 214 by analyzing the market demand data set 304, the market availability data set 306 and the market consumption data set 308 and outputs the identified marketing opportunities to a user in any manner and/or type(s) of formats, such as a textual format and/or a graphical format. For example, the market opportunity identifier 310 may analyze the market demand data set 304, the market availability data set 306 and the market consumption data set 308 to determine the marketing opportunities 214 to improve the return on investment of marketing activities and to forecast further opportunities for healthcare products and generate a written report containing the marketing opportunities 214.

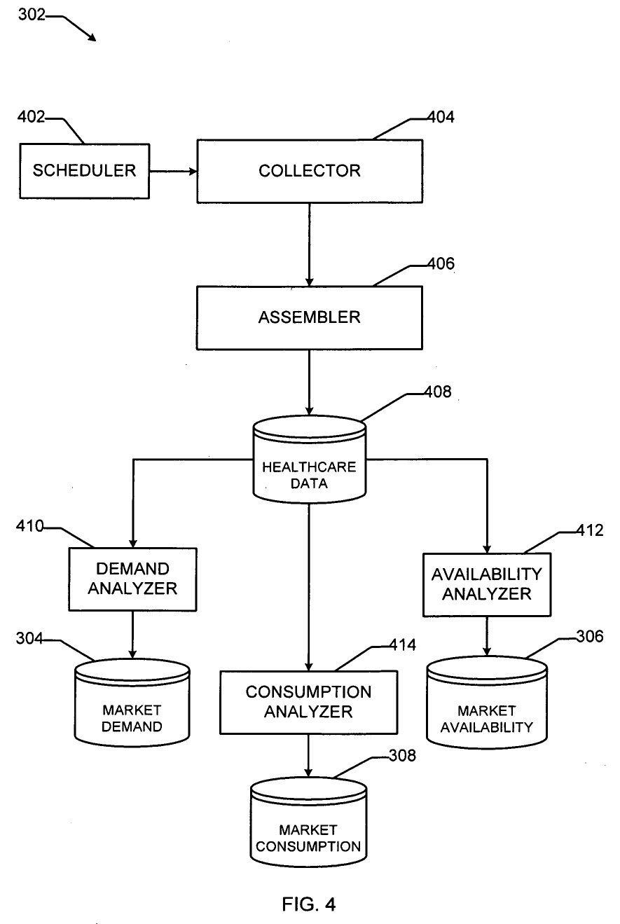

FIG. 4 is a block diagram representation of the data set generator 302 of FIG. 3. The example implementation of the data set generator 302 includes a scheduler 402, a collector 404, an assembler 406, a healthcare data set 408, a demand analyzer 410, an availability analyzer 412, and a consumption analyzer 414. The example data set generator 302 may be implemented using any desired combination of hardware, firmware and/or software. For example, one or more integrated circuits, processing devices, discrete semiconductor components and/or passive electronic components may be used to implement the example data set generator 302.

Generally, the data set generator 302 is configured to determine the market demand data set 304, the market availability data set 306 and/or the market consumption data set 308, all of which may be used to identify the marketing opportunities 214 within a healthcare market 100. More specifically, the example scheduler 402 determines when the collector 404 collects data from the data sets collected by the market research companies (e.g., the consumer behavior data set 202, the consumer profiles data set 206, the healthcare products data set 208 and/or the healthcare statistics data set 210). The scheduled collections triggered by the scheduler 402 may occur periodically (e.g., at 11:00 p.m., every Friday), or aperiodically (e.g., when the scheduler 402 detects that the consumer behavior data set 202 has been updated).

Once triggered by the scheduler 402, the example collector 404 collects the data from the consumer behavior data set 202, the consumer profiles data set 206, the healthcare products data set 208 and/or the healthcare statistics data set 210. For example, the collector 404 loads a market research data set (e.g., the healthcare products data set 206) into a computer readable medium (e.g., a memory and/or a mass storage device) for further processing within the example data set generator 302. The computer readable medium may be a non-volatile memory (e.g., a flash memory), a mass storage device (e.g., a disk drive), a volatile memory (e.g., static or dynamic random access memory) and/or any combination of the memory types.

The example collector 404 may then collect the complete consumer behavior data set 202, the consumer profiles data set 206, the healthcare products data set 208 and the healthcare statistics data set 210 or only a portion of a data set (e.g., an updated selection of data within one or more of the market research data sets). Once the market research data sets are collected by the collector 404, the assembler 406 generates the healthcare data set 408 organized by healthcare consumer 104, provider 106, retailer 108, payor 110, and government organization 112 according to geographic locations (e.g., an area defined by an extended zip code).

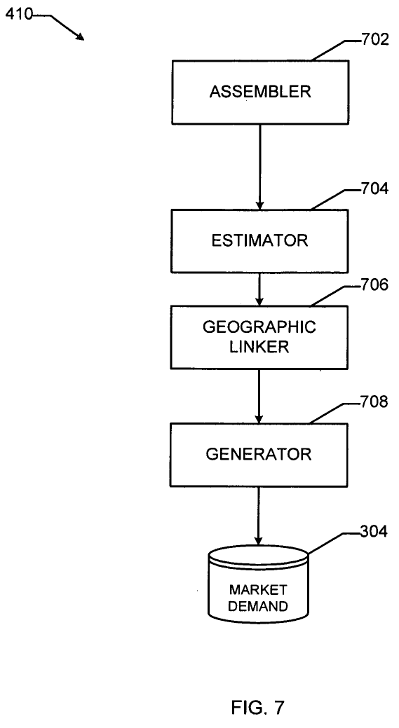

The example demand analyzer 410 then analyzes the healthcare data set 408 to determine the market demand data set 304 in terms of characteristics of the healthcare consumer 104 (e.g., demographics, economics, ethnicity, spending, etc.) as discussed in detail below in conjunction with FIG. 7. For example, the demand analyzer 410 first analyzes the data integrated from the consumer behavior data set 202, the consumer profiles data set 206, the healthcare products data set 208 and/or the healthcare statistics data set 210. The example demand analyzer 410 then estimates a likelihood of a healthcare need for healthcare consumers 104 within a geographic area (e.g., a region defined by a postal zip code) or market segment (e.g., a segment defined by age, gender and/or ethnicity) based on the analysis. Further the example demand analyzer 410 links the likelihood of the healthcare need to the characteristics of the healthcare provider 106, retailer 108 and/or payor 110.

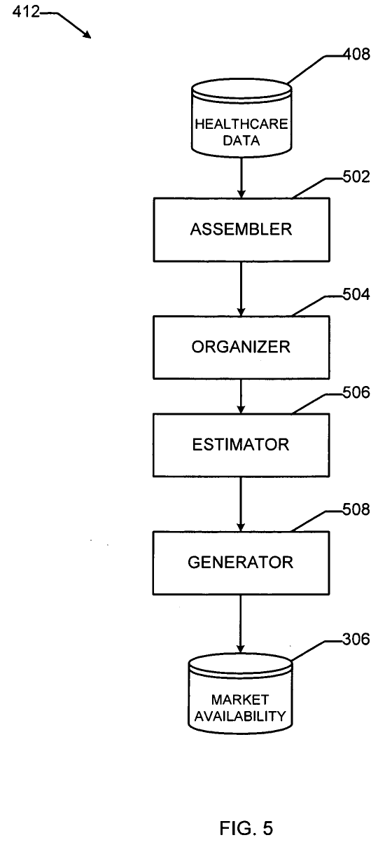

The example availability analyzer 412 analyzes the data in the example healthcare data set 408 to determine the market availability data set 306 in terms of the availability of a healthcare product by price across provider affiliations (e.g., a healthcare consumer relationship or membership in healthcare networks), payor formularies, geographic locations and/or consumer segments. The example availability analyzer 412 further derives a provider affiliation estimate, a provider coverage estimate and a payor coverage estimate from the healthcare data set 408 by analyzing claims data, formulary data and dispensing records, respectively. The example availability analyzer 412 is discussed in detail below in conjunction with FIG. 5.

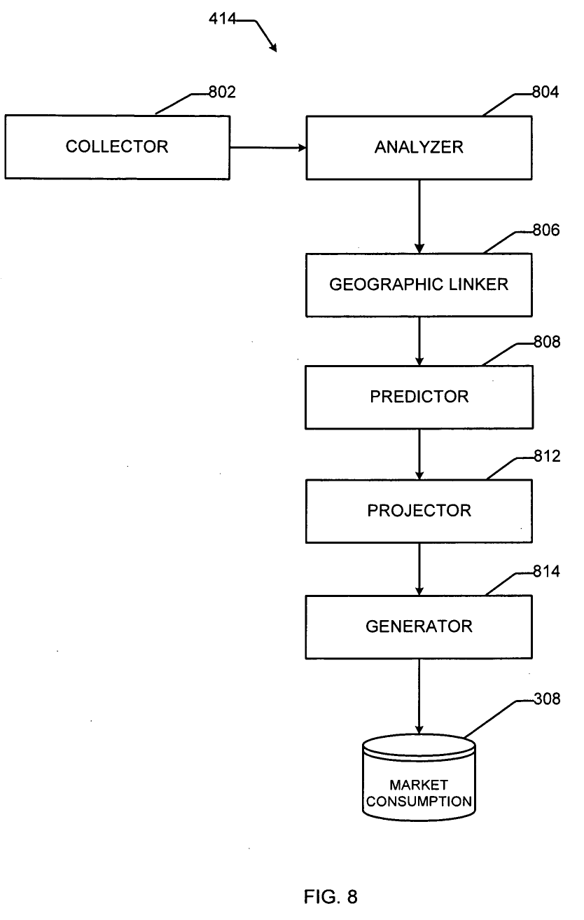

The example consumption analyzer 414 analyzes the data in the example healthcare data set 408 to determine the market consumption data set 308 in terms of behavior of healthcare consumers 104 by examining aggregate retail sales (e.g., OTC product sales and/or prescription product sales) and the use of healthcare products by individual healthcare consumers 104. The example consumption analyzer 414 predicts a treatment characteristic (e.g., a prescription usage characteristic) for a population of healthcare consumers 104 (e.g., a Homescan® panel) based on the analysis of characteristics of a sufferer panel (e.g., a panel of healthcare consumers 104 with a particular healthcare need), the characteristics of the syndicated panel, and a healthcare product characteristic (e.g., a prescription product usage characteristic). Further, the predicted treatment characteristic is projected to a population of healthcare consumers (e.g., a national population, a regional population, etc.). The consumption analyzer 414 is discussed in detail below in conjunction with FIG. 8

A block diagram depicting an example implementation of the example availability analyzer 412 of FIG. 4 is illustrated in FIG. 5. The example availability analyzer 412 includes an assembler 502, an organizer 504, an estimator 506 and a generator 508. The example availability analyzer 412 may be implemented using any desired combination of hardware, firmware and/or software. For example, one or more integrated circuits, processing devices, discrete semiconductor components and/or passive electronic components may be used to implement the example availability analyzer 412.

Generally, the availability analyzer 412 analyzes the example healthcare data set 408 to generate the market availability data set 306, which at least partially defines the healthcare market 100 of a healthcare product. More specifically, the availability analyzer 412 of the illustrated example estimates provider and/or payor characteristics from the various data sources (e.g., the example consumer behavior data set 202, the example consumer profiles data set 206, the example healthcare products data set 208, and/or the example healthcare statistics data set 210 of FIG. 2). The example availability analyzer 412 then generates the example market availability data set 306 based on the estimated characteristics, formulary data, price and copay data, product substitution data, and/or population coverage characteristics. The market availability data set 306 generated by the availability analyzer 412 of the illustrated example provides data useful to healthcare product manufacturers 102 to define the healthcare market 100 in terms of treatment availability based on price points of healthcare products across provider affiliations, payor formularies, geographic locations and/or consumer segments.

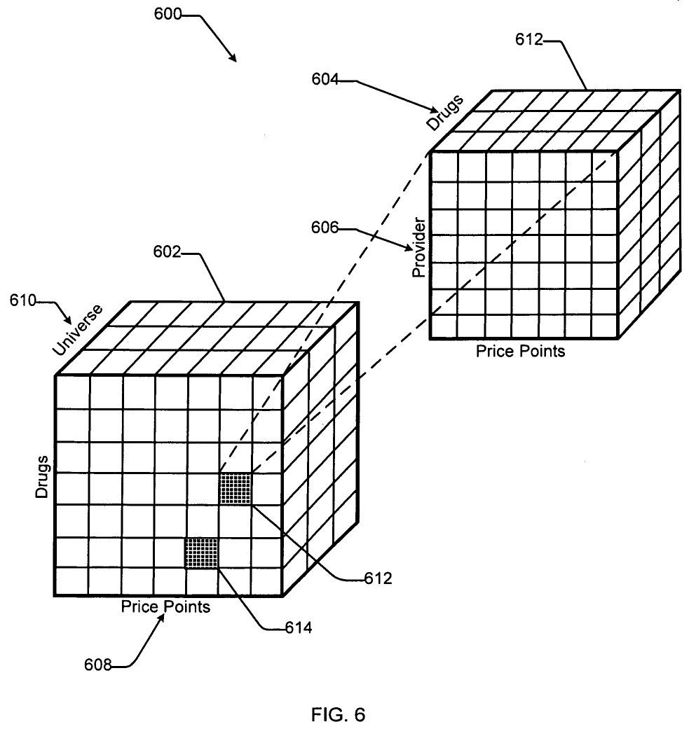

The example assembler 502 of the illustrated example gathers data corresponding to the use of a healthcare product from the healthcare data set 408 for a geographic area of interest. For example, the assembler 502 may gather information including a government (e.g., Medicare) data record, a syndicated formulary database, a syndicated claims data record (e.g., claims submitted by a healthcare provider 106 and/or a retailer 108), and/or retailer characteristics. Next, the example organizer 504 organizes the data gathered from the healthcare data set 408 into a multidimensional matrix represented by an example data structure 600 (FIG. 6). For example, the organizer 504 organizes the data into a healthcare product (e.g., a drug) dimension, a provider dimension, a payor dimension, a retailer dimension (e.g., a pharmacy), and a price dimension. Further, the dimensions are referenced to a geographic location, such as an extended zip code, in a universe dimension. The multidimensional matrix represented by the example data structure 600 is described in detail below in conjunction with FIG. 6.

Next, the estimator 506 of the illustrated example estimates a provider affiliation characteristic, a provider coverage characteristic and/or a payor coverage characteristic from claims data, formulary data and/or dispensing records gathered from the healthcare data set 408. The provider characteristics and/or payor characteristics estimated by the estimator 506 are then stored, for example, in the example data structure 600 of FIG. 6 at local zip code granularity to provide insight into factors (e.g., a payor plan participation rate, a formulary penetration characteristic, and a price and/or copay cost of healthcare product, etc.) affecting the treatment availability for a geographic area. Further, the availability of healthcare products to healthcare consumers 104 is affected by factors associated with the healthcare consumer's 104 choice of a healthcare provider 106 and/or retailer 108.

Healthcare consumers 104 choose healthcare providers 106 based on a variety of reasons, which include payor affiliations and/or location. For example, a healthcare consumer 104 typically has a limited choice of payor healthcare plans offered through an employer and/or government organization. Further, healthcare providers 106, and/or their associated medical group, accept a subset of health insurance plans offered by the payors 110. Additionally, a healthcare consumer 104 may also be limited in choosing a healthcare provider 106 because the payor 110 may offer reduced coverage for treatment by providers 106 outside a payor approved network of healthcare providers 106. Therefore, the provider coverage characteristic, provider affiliation characteristic and payor coverage characteristic estimated by the example estimator 506 are useful to healthcare product manufacturers 102 in identifying the marketing opportunities 214 for a healthcare product.

The estimator 506 of the illustrated example estimates the provider affiliation characteristic (e.g., the affiliation with the payor 110) from claims data (e.g., a prescription claim or a service claim) associated with a geographic area (e.g., a healthcare provider coverage area or a hospital service area) gathered from the healthcare data set 408. The provider affiliation characteristic provides useful information associated with the provider choices available to a healthcare consumer 104 within a chosen geographic area. For example, a healthcare consumer 104 may choose a healthcare provider 106 located within a geographic area close to the consumer's home. The choices of providers 106 available to consumers 104 are limited by the affiliations with payors that provide healthcare insurance to the healthcare consumer 104. Due to the cost of healthcare services, healthcare consumers 104 typically choose a healthcare provider 106 affiliated with their payor 110. Further, a healthcare consumer 104 typically purchases healthcare products from retailers 108 located within the same geographic area associated with both the healthcare consumer 104 and their chosen healthcare provider 106.

The estimator 506 of the illustrated example estimates the provider affiliation characteristic by first determining a geographic area associated with a healthcare provider 106 (e.g., the provider coverage area) and/or a retailer 108 within that same geographic area. Next, the example estimator 506 analyzes the claims data associated with the healthcare provider 106 and the retailers 108 to determine affiliations between the healthcare provider 106 and the payor 110 for the segment of the population sampled by the market research company. The example estimator 506 then analyzes the determined affiliations along with consumer demographic information for the population within the provider coverage area to estimate payors 110 affiliated with a healthcare provider 106 within the geographic area of interest by analyzing the consumer characteristics of the sampled population and the consumer demographic data.

Further, the estimator 506 of the illustrated example estimates the provider coverage characteristic based on formulary data associated with a payor 110. The formulary is a list of healthcare products approved for coverage under a healthcare plan provided by a payor 110 and may include tiers (e.g., generic, preferred brand, non-preferred brand, or specialty) determining a copay amount responsibility of the healthcare consumer 104. The estimator 506 analyzes the formulary lists, formulary tiers and provider affiliations to estimate a provider coverage characteristic that represents, for example, a percentage of time that a healthcare provider 106 may prescribe a particular healthcare product. For example, the estimator 506 may estimate a provider coverage characteristic for a healthcare provider 106 that is affiliated with a number of payors 110 utilizing three different formularies. The example estimator 506 analyzes the number of plans offered by a payor 110, the number of healthcare consumers 104 enrolled in the plans to determine a percentage of the population within the geographic area covered by the affiliated plans. Additionally, the example estimator 506 analyzes the formulary tiers to determine a coverage area for a healthcare product of interest along with the percentage of the healthcare consumers 104 covered by the payor plans affiliated with each formulary. The estimator 506 of this example may then determine a payor coverage characteristic where the healthcare provider 106 can prescribe a particular drug (e.g., drug X thirty five percent of the time).

A third characteristic estimated by the estimator 506 of the illustrated example is the payor coverage characteristic estimated through, for example, an analysis of dispensing records. A dispensing record is a record kept by the retailer 108 (e.g., a pharmacy) for each prescription filled and contains information associated with the healthcare product and the associated healthcare consumer 104. Further, the payor coverage characteristic is used to link the provider 106 to a prescription for a healthcare product, the prescription to retail dispensing and retail dispensing to a specific payor 110. For example, the estimator 506 of the illustrated example may use the dispensing records from a retailer 108 in to create a record illustrating the prescription usage for consumers 104 within the geographic area serviced by the retailer 108 (e.g., a retail coverage area). The example estimator 506 then associates the dispensing records with a payor 110 through claims data submitted to the payor 110 for prescriptions from the same retail coverage area. Next, the example estimator 506 estimates the payor coverage characteristic by analyzing the dispensing records from the retailer 108, the claims data corresponding to the retail coverage area and/or healthcare consumer segmentation data. An example payor coverage characteristic is the percentage of healthcare consumers 104 within a geographic area receiving coverage from a payor 110.

Next, the generator 508 creates the market availability data set 306 by compiling the fact-based data (e.g., a formulary list, a prescription price, a prescription copay, a prescription substitution record, etc.) assembled from the healthcare data set 408 along with the estimates (e.g., the provider affiliation estimate, the provider coverage estimate, and the payor coverage estimate) generated by the estimator 506 into the multidimensional matrix or data structure 600 as represented by the data structure 602 of FIG. 6. The generator 508 stores the data (e.g., the fact-based data and the estimated data) within the multidimensional matrix 600 according to a relatively small geographic location (e.g., an area represented by an extended zip code) to enable analysis to be accomplished over larger geographic area (e.g., a health service area, manufacturer sales territory, demographic segments, etc.).

As mentioned above, FIG. 6 is an example representation of the multidimensional matrix or data structure 600 that may be used to store a data set (e.g., the market availability data set 306) to facilitate the analysis of healthcare markets. For clarity, the multidimensional matrix 600 is represented as a data cube 602 and contains data representative of the consumer healthcare market. Such data (e.g., corresponding to the dimensions of the data structure or cube) include healthcare products (e.g., drugs 604), healthcare providers 106 (e.g., a provider 606), healthcare costs (e.g., a price 608) and geographic location (e.g., universe 610), healthcare consumers 104 (e.g., consumer demographics), and/or retailers 108 (e.g., pharmacy characteristics). The multidimensional matrix 600 generated by the generator 508 may be stored in a data file in any format similar to those discussed above in conjunction with the example data sets 202 and 206-210 of FIG. 2.

The generator 508 generates the market availability data set 306 by organizing data assembled from the healthcare data set 408 along with estimates generated via the estimator 506 into dimensions within the matrix 600 by geographic location. To facilitate further analysis of the availability of healthcare products within a healthcare market for the multidimensional matrix 600, the data is referenced to the geographic location.

As mentioned above, healthcare product manufacturers 102 simultaneously market healthcare products to distinct, but interrelated groups (e.g., the healthcare providers 106, the retailers 108, the payors 108 and the consumers 104). To facilitate the marketing efforts to these distinct groups, the data stored within the market availability data set 306 is stored within the multidimensional matrix 600 according to an extended zip code. By storing the data referenced to a small geographic area, the universe dimension 610 retains a high level of granularity, thereby enabling flexibility in defining the scope of the universe 610 useful in targeting marketing efforts to specific groups. Examples of the targeted marketing efforts include, but are not limited to, efforts to target markets with price advantage to grow market share, prioritizing promotional spending in markets with a likelihood of increasing market share, targeting payors 110 by a local market in formulary and tier negotiations, and realigning sales forces to increase the product availability in markets with a low market share.

For example, the universe dimension 610 may be defined in terms of direct observations such as health service areas, manufacturer sales territories or coverage areas for healthcare providers 106 or retailers 108. Additionally, the universe dimension 610 may be defined in terms of imputed groupings such as subscriber employee territories or demographic segments. A healthcare market may be defined as a geographic region bounded by the coverage area of a healthcare provider 106 and the data within the market availability data set 306 may be analyzed to determine characteristics of the market to facilitate the marketing efforts within that geographic area. For example, the data within the market availability data set 306 may indicate that in the region 612, the provider coverage area for the healthcare provider (e.g., Doctor G), is affiliated with three payors 110 covering 34% of the population within the region 612 and can prescribe a healthcare product (e.g., drug D) by brand 37% of the time. In another example, in a region 614 (e.g., a health service area), a specific healthcare product (e.g., drug X) is priced higher (e.g., has higher copays for healthcare consumers 104) than a competing product (e.g., drug Y) for 85% of the potential patients.

FIG. 7 is a block diagram representation of an example implementation of the example demand analyzer 410 of FIG. 4. The example demand analyzer 410 includes an assembler 702, an estimator 704, a geographic linker 706 and a generator 708 to generate the market demand data set 304 of FIG. 3. The example demand analyzer 410 may be implemented using any desired combination of hardware, firmware and/or software. For example, one or more integrated circuits, processing devices, discrete semiconductor components and/or passive electronic components may be used to implement the example demand analyzer 410.

Generally, the example methods and apparatus described herein analyze a study corresponding to a healthcare need (e.g., a study describing mortality rates for a disease) and data describing the healthcare market 100 of FIG. 1, including data related to the consumer 104, the provider 106, the retailer 108 and the payor 110 data (e.g., demographics, location, treatment preferences, claims information, formulary data, etc.) to generate the market demand data set 304. More specifically, the assembler 702 of the illustrated example assembles data associated with a healthcare need (e.g., a disease prevalence study, a mortality rate study, healthcare consumer demographic data, healthcare product usage data, etc.) and stores the data in a memory according to a geographic location and/or consumer segment. The example assembler 702 may be integrated within the assembler 406 of FIG. 4 or implemented as an independent set of machine-readable instructions executed by the processor 2302 of the processor system 2300. The data assembled by the example assembler 702 may be stored, for example, in a data file in any format similar to those discussed above in conjunction with the example data sets 202 and 206-210 of FIG. 2.

Once the example assembler 702 assembles the healthcare need data, the estimator 704 of the illustrated example analyzes the assembled data. The example estimator 704 then estimates a likelihood of a specific healthcare need for healthcare consumers 104 residing within a geographic area and/or belonging to a consumer segment. More specifically, the example estimator 704 analyzes two or more studies correlating to a healthcare need collected from a government organization 112 (e.g., the National Center for Health Statistics) or another source (e.g., a university sponsored study) and determines a correlation between the studies. Further, the example estimator 704 analyzes the determined correlation with information associated with the healthcare consumer 104, the healthcare provider 106, the payor 110, and the retailer 108 (e.g., consumer demographic data, claims data, etc.) to identify differences in availability of healthcare products and treatment opportunities. The example estimator 704 then estimates a likelihood of a specific healthcare need by location and/or consumer segment from the study data and the marketplace data.

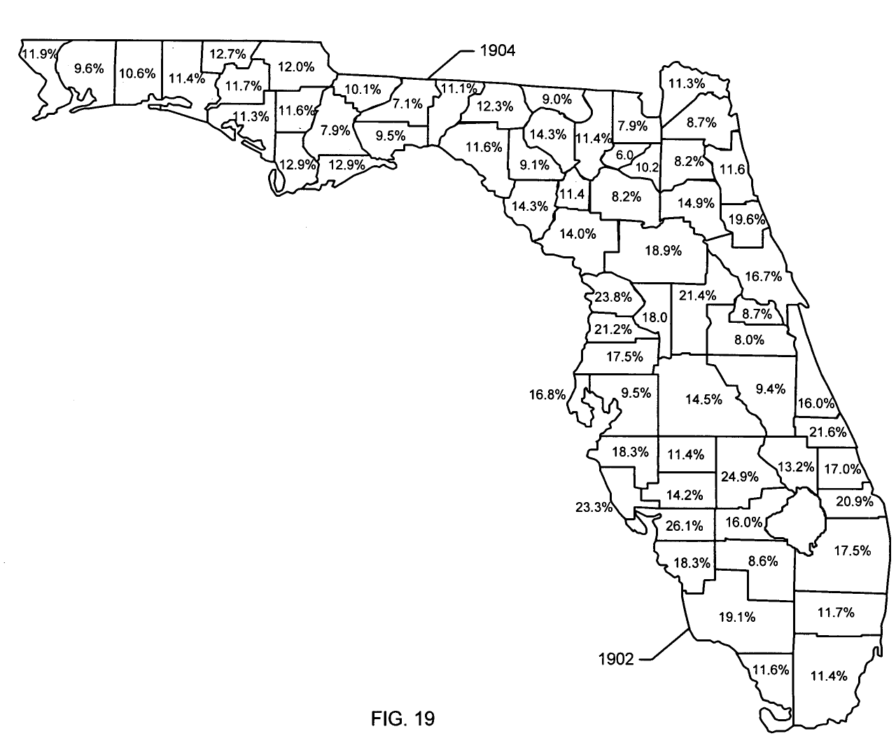

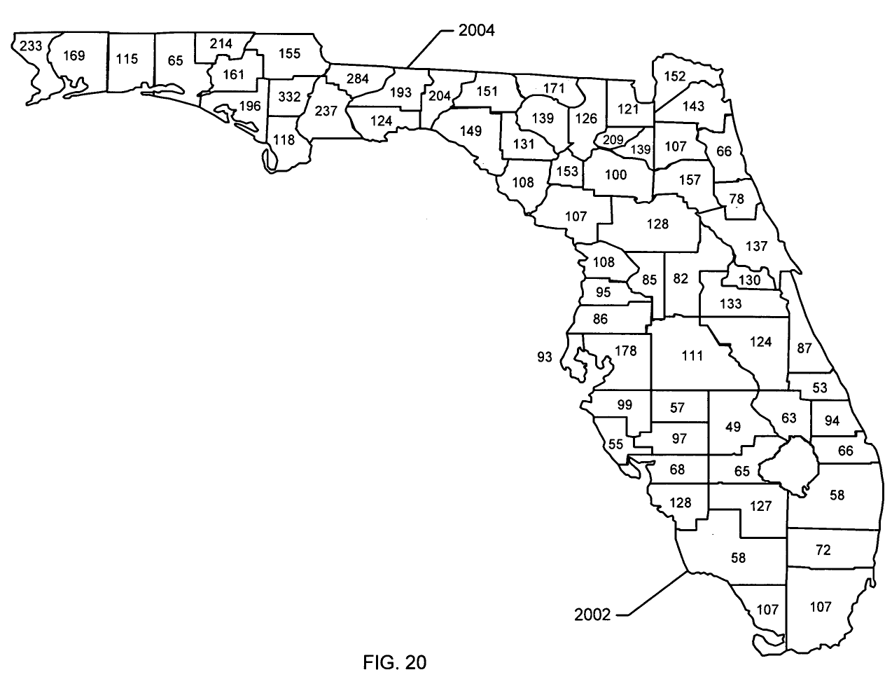

In an example illustrating the operation of the estimator 704, the estimator 704 examines a study of hypertension prevalence rates for people over the age of 65 (e.g., the example study illustrated in FIG. 19), analyzes the study data along with a hypertension mortality rate study over the same geographic area (e.g., the example study illustrated in FIG. 20), and determines that the hypertension mortality rates inversely correlate to the disease prevalence. Then, the example estimator 704 analyzes the correlation determined from the studies and the healthcare consumer 104 characteristics (e.g., demographics, ethnicity, lifestyles, spending, media consumption habits, etc.) to estimate a likelihood of specific healthcare needs, such as treatment for hypertension, for a geographic location and/or consumer segment.

Once the estimator 704 estimates the likelihood of specific healthcare needs, the example geographic linker 706 links the likelihoods to characteristics of the healthcare providers 106, the retailers 108 and the payors 110, such as payor coverage areas, formulary coverage statistics, and provider coverage areas. Next, the generator 708 generates the estimated likelihood and the linked characteristics into the market demand data set 304. The market demand data set 304 defines the market demand for a healthcare product in terms of an identified need, an awareness of the identified healthcare need, treatment opportunities and/or treatment affordability within a specified geographic area.

A block diagram depicting an example implementation of the consumption analyzer 414 of FIG. 4 is illustrated in FIG. 8. The example implementation of the consumption analyzer 414 includes a collector 802, an analyzer 804, a geographic linker 806, a predictor 808, a projector 812 and a generator 814 to generate the example market consumption data set 308. The example consumption analyzer 414 may be implemented using any desired combination of hardware, firmware and/or software. For example, one or more integrated circuits, processing devices, discrete semiconductor components and/or passive electronic components may be used to implement the example consumption analyzer 414.

In general, the example consumption analyzer 414 stores a measure of healthcare consumption in terms of healthcare product usage for individuals and market level performance (e.g., prescription usage and/or OTC sales) in the market consumption data set 308. More specifically, the example methods and apparatus described herein utilize the example collector 802 to collect information associated with the use of a healthcare product by healthcare consumers 104 having a healthcare need further associated with the healthcare product. The collector 802 collects the information associated with the use of the healthcare product via inference from panelist data collected from a consumer behavior panel such as Homescan®. Alternatively or additionally, the example collector 802 gathers the healthcare product usage information from a sufferer panel. The sufferer panel information may be gathered by a market research company from healthcare consumers 104 that suffer from a specific healthcare need (e.g., hypertension, diabetes, allergies, etc.) to provide insight into the consumers 104 attitudes and behaviors driving their purchasing decisions corresponding to their healthcare needs.

Next, the analyzer 804 of the illustrated example assembles the collected data from sufferer panels and/or syndicated surveys, prescription claims data, and sales data from the retailers 108 (e.g., prescription sales and/or OTC sales). The example analyzer 804 analyzes the assembled data to determine a patient usage characteristic and/or a market performance characteristic associated with a healthcare product. For example, the example analyzer 804 determines a patient usage characteristic from the assembled data indicating that a consumer 104 with a healthcare need showing that the healthcare consumers 104 chose to purchase a specific OTC product in addition to a prescription product 30% of the time. An example market performance characteristic determined by the analyzer 804 may include the statistics showing that a prescription product (e.g., a drug brand X), was purchased over a competing product (e.g., brand Y) by 65% of consumers 104 with the healthcare need within the specified geographic location.

The example geographic linker 806 links the patient usage characteristic to the market performance characteristic and/or characteristics of the provider 106, the payor 110 and/or the retailer 108 (e.g., a payor coverage area, a formulary coverage statistics, a provider coverage area, etc.). The geographic linker 806 links the characteristics by associating the patient usage characteristic and/or the market performance characteristic to the geographic location corresponding to the healthcare consumer 104 and/or retailer 108.

Next, the example predictor 808 analyzes the patient and/or market performance characteristics with actual prescription and/or claims data to predict prescription behavior for a known population. For example, the analyzer 804 of the illustrated example determines a patient usage characteristic and a market usage characteristic based on data obtained from a sufferer panel. The predictor 808 then predicts prescription behavior for a syndicated panel (e.g., the Homescan® panel) based on a matched sample overlap between the syndicated panel and the sufferer panel. The example projector 812 then projects the predicted prescription behavior of the syndicated panel to a larger population of healthcare consumers 104. For example, syndicated panels are designed so that the panelists are representative of healthcare consumers 104 as a whole so that a behavior predicted for a syndicated panel may be projected to a population in a regional area (e.g., a zip code, city, county, etc.), a national population and/or consumer segment.

Once the example projector 812 projects the predicted behavior to a larger population, the generator 814 generates the market consumption data set 308. The market consumption data set 308 provides four levels of coverage and/or precision useful in generating the marketing opportunities 214. The predictions and projections stored in the example market consumption data set 308 may be analyzed by matching actual measured panel behavior and attitudes with predicted treatment, actual healthcare product usage during treatment and actual measured panel behavior and attitudes, actual healthcare product usage during treatment and predicted panel behavior and attitudes, and/or projected healthcare product usage during treatment and projected panel behavior and attitudes.

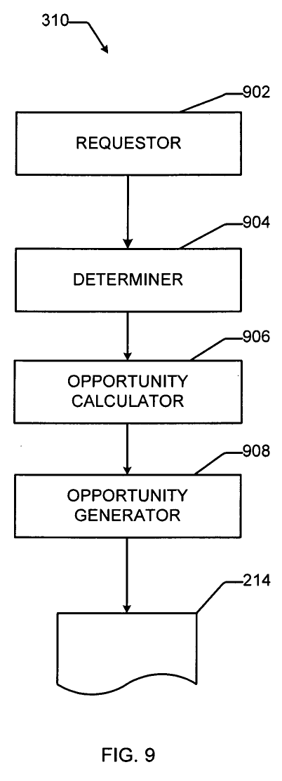

A block diagram depicting an example implementation of the example market opportunity identifier 310 of FIG. 3 is illustrated in FIG. 9. The example implementation of the market opportunity identifier 310 includes a requestor 902, a determiner 904, a calculator 906 and an opportunity generator 908. The example market opportunity identifier 310 may be implemented using any desired combination of hardware, firmware and/or software. For example, one or more integrated circuits, processing devices, discrete semiconductor components and/or passive electronic components may be used to implement the example market opportunity identifier 310.

Generally, the market opportunity identifier 310 of the illustrated example analyzes the market demand data set 304, the market availability data set 306, and/or the market consumption data set 308 to identify the marketing opportunities 214. More specifically, a user via the requester 902 of the example market opportunity identifier 310 may request one or more marketing opportunities. Additionally or alternatively, the requester 902 may be configured to generate a marketing opportunity based on pre-determined criteria and the example implementation should not be construed as limiting. An example marketing opportunity request may include a market location opportunity request configured to identify markets with price advantage so targeted marketing efforts may be implemented to grow market share.

Once a marketing opportunity request is obtained via the example requester 902, the example determiner 904 determines one or more of the market demand data set 304, the market availability data set 306, and/or the market consumption data set 308 containing data useful in determining the requested marketing opportunity. Example marketing requests include a strategy to target formulary development (e.g., including a healthcare product on a formulary and/or changing a formulary tier associated with the healthcare product) or a request to prioritize marketing investments by location and/or provider.

For example, if the request identified by the requestor 902 is the aforementioned strategy to target formulary development for a geographic region (e.g., a state), the determiner 904 determines that the example marketing opportunity identifier 214 determines the marketing opportunity from the market demand data set 304 and the market availability data set 306. Alternatively, if the requested marketing opportunity is the aforementioned request to prioritize the marketing investments of a healthcare manufacturer 102 for a location, the determiner 904 determines that the marketing opportunity is generated from the market availability data set 306.

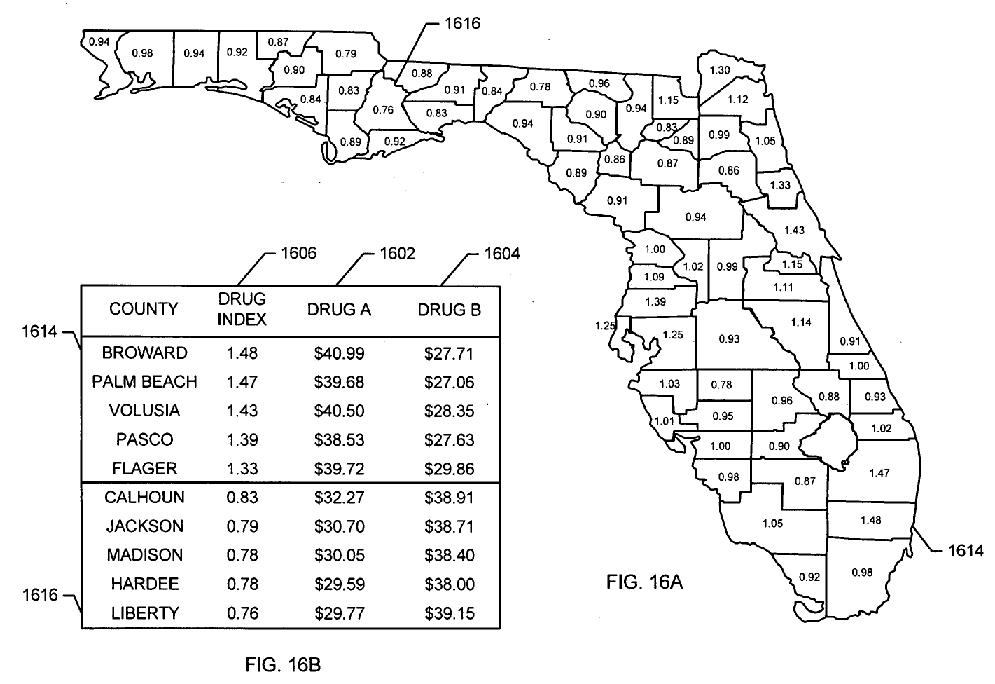

Next, the example opportunity calculator 906 analyzes data within the data sets identified (e.g., the market demand data set 304, the market availability data set 306, and/or the market consumption data set 308) to determine the marketing opportunities 214. For example, to determine a marketing opportunity from a request to target counties with a price advantage to improve market share, the calculator 906 analyzes data in the market demand data set 304. An example method utilized by the example calculator 906 may calculate average consumer copays for competing healthcare products for each county in a state, an example of which is discussed below in conjunction with FIGS. 16A and 16B. This example method only represents one method of determining or calculating a marketing opportunity 214 from the example market demand data set 304 and should not be considered limiting. The example opportunity calculator 906 may output a list of copay costs useful in determining the marketing opportunity 214 by the example opportunity generator 908.

The opportunity generator 908 of the illustrated example generates and/or outputs the marketing opportunities 214 from the data calculated by the opportunity calculator 906 in response to a marketing opportunity request processed by the requestor 902. The example opportunity generator 908 may generate and/or output the marketing opportunities 214 in a graphical and/or textual format in any manner and/or type(s) of reporting methods including, but not limited to, displaying on a video terminal or generating a hardcopy using a printer or plotter. For example, the opportunity generator 908 may analyze the copay data from the opportunity calculator 906 example to determine a marketing opportunities 214 to target marketing efforts in the counties with the lowest copay cost in order to increase market share and generate a printed report.

While an example manner of implementing the healthcare market analyzer 212 of FIG. 2 has been illustrated in FIGS. 2-5 and 7-9, one or more of the elements, processes and/or devices illustrated in FIGS. 2-5 and 7-9 may be combined, divided, re-arranged, omitted, eliminated and/or implemented in any other way. Further, the data set generator 302, the market demand data set 304, the market availability analyzer 306, the market consumption data set 308, the market opportunity identifier 310, the scheduler 402, the collector 404, the assembler 406, the healthcare data set 408, the demand analyzer 410, the availability analyzer 412, the consumption the analyzer 414, the assembler 502, the organizer 504, the estimator 506, the generator 508 the assembler 702, the estimator 704, the geographic linker 706, the generator 708, the collector 802, the analyzer 804, the geographic linker 806, the predictor 808, the projector 812, the generator 814, the requester 902, the determiner 904, the opportunity calculator 906, the opportunity generator 908, and/or, more generally, the healthcare market analyzer 212 of FIGS. 2-5 and 7-9 may be implemented by hardware, software, firmware and/or any combination of hardware, software and/or firmware. Thus, for example, any of the data set generator 302, the market demand data set 304, the market availability analyzer 306, the market consumption data set 308 and the market opportunity identifier 310, the scheduler 402, the collector 404, the assembler 406, the healthcare data set 408, the demand analyzer 410, the availability analyzer 412, the consumption analyzer 414, the assembler 502, the organizer 504, the estimator 506, the generator 508 the assembler 702, the estimator 704, the geographic linker 706, the generator 708, the collector 802, the analyzer 804, the geographic linker 806, the predictor 808, the projector 812, the generator 814, the requester 902, the determiner 904, the opportunity calculator 906, the opportunity generator 908, and/or, more generally, the healthcare market analyzer 212 of FIGS. 2-5 and 7-9 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of, the data set generator 302, the market demand data set 304, the market availability analyzer 306, the market consumption data set 308 and the market opportunity identifier 310, the scheduler 402, the collector 404, the assembler 406, the healthcare data set 408, the demand analyzer 410, the availability analyzer 412, the consumption analyzer 414, the assembler 502, the organizer 504, the estimator 506, the generator 508 the assembler 702, the estimator 704, the geographic linker 706, the generator 708, the collector 802, the analyzer 804, the geographic linker 806, the predictor 808, the projector 812, the generator 814, the requester 902, the determiner 904, the opportunity calculator 906, the opportunity generator 908 are hereby expressly defined to include a tangible medium such as a memory, DVD, CD, etc. storing the software and/or firmware. Further still, the healthcare market analyzer 212 of FIG. 2 may include one or more elements, processes and/or devices in addition to, or instead of, those illustrated in FIGS. 2-5 and 7-9, and/or may include more than one of any or all of the illustrated elements, processes and devices.

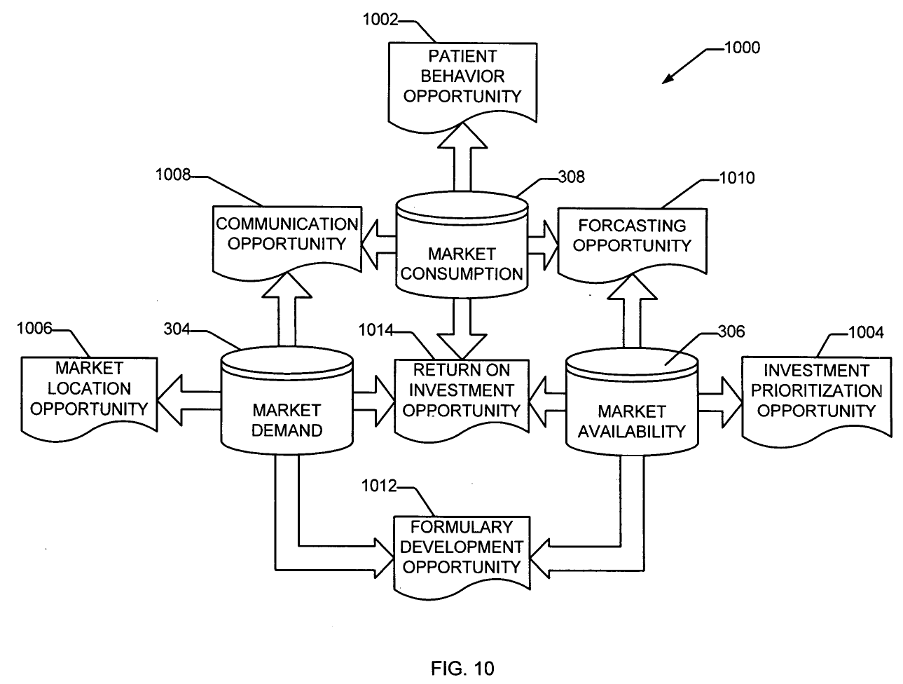

FIG. 10 depicts an example block diagram representation of a marketing opportunity generation system 1000 utilizing one or more of the market demand data set 304, the market availability data set 306, and/or the market consumption data set 308 to generate the example marketing opportunities 214 of FIG. 2. The example marketing opportunities 214 include a patient behavior opportunity 1002, an investment prioritization opportunity 1004, a market location opportunity 1006, a communication opportunity 1008, a forecasting opportunity 1010, a formulary development opportunity 1012 and/or a return on investment opportunity 1014. The marketing opportunities 1002, 1004, 1006, 1008, 1010, and 1014 are merely example marking opportunities that may be determined from the data contained in the example market demand data set 304, the market availability data set 306 and/or the market consumption data set 308 and should not be construed as limiting. The marketing opportunities may be stored electronically on an electronic medium (e.g., a mass storage device, a memory, a CD, a DVD, etc), displayed on a display (e.g., an LCD monitor, a CRT monitor, etc.) provided via printed media (e.g., a printed report, a letter, etc.) and/or any other method for disseminating information to an individual.

As discussed above in conjunction with FIG. 9, the example market opportunity identifier 310 determines the marketing opportunity 214 by analyzing at least one of the market demand data set 304, the market availability data set 306, or the market consumption data set 308. For example, the patient behavior opportunity 1002, the investment prioritization opportunity 1004 and/or the market location opportunity 1006 may be determined by examining, respectively, the market consumption data set 308, the market availability data set 306 and the market demand data set 304. The example marketing opportunity identifier 310 may identify the example patient behavior opportunity 1002 by analyzing patient behavior related to a healthcare need and a healthcare product, tracking competitive product usage and/or OTC and prescription healthcare product interaction. The example investment prioritization opportunity 1004 may be determined from the market availability data set 306 by analyzing this data to determine marketing opportunities identified by a geographic location and/or healthcare provider 106. The market opportunity identifier 310 may identify the example market location opportunity 1006 by analyzing the market demand data set 304 to determine, for example, a geographic location with favorable price points for a healthcare product as compared to competing products.

The example market opportunity identifier 310 of FIGS. 3 and 9 may examine two or more of the market demand data set 304, the market availability data set 306 or the market consumption data set 308 to determine the marketing opportunity (e.g., the communication opportunity 1008, the forecasting opportunity 1010, the formulary development opportunity 1012, etc.). The example communication opportunity 1008 may be determined by the example market opportunity identifier 310 from the example market demand data set 304 and the example market consumption data set 308. For example, by analyzing data associated with a market demand (e.g., copay cost, list price, etc) with data associated with the consumption of a healthcare product (e.g., actual patient consumption, predicted patient consumption, etc.), the market opportunity identifier 310 may generate a communication opportunity 1008 quantifying communicating strategies and/or targeting delivery to increase patient consumption and demand for the healthcare product.

The example market opportunity identifier 310 may generate the example forecasting opportunity 1010 by analyzing the market availability data set 306 and the market consumption data set 308. For example, the example market opportunity identifier 310 may generate the example forecasting opportunity 1010 by analyzing the patient behavior and consumption patterns along with the availability data for a healthcare product to identify geographic locations to launch a new product and forecast a likelihood of success for a new product launch. The example market opportunity identifier 310 may identify the example formulary development opportunity 1012 by analyzing the market demand data set 304 and the market availability data set 306. For example, the market opportunity identifier 310 of the illustrated example may analyze the market demand data set 304 and the market availability data set 306 to determine that the top two payors 110 in the state of Florida have a 56% market share and eighty-two other plans share the remaining market. Further, a healthcare demand for the healthcare product of interest exists, but competing products may have a similar and/or a more favorable copay cost. The example market opportunity identifier 310 then generates a formulary development opportunity 1012 detailing local markets that are favorable for formulary pricing negotiations to improve the market share of the healthcare product.

The example market opportunity identifier 310 may analyze the market demand data set 304, the market availability data set 306 and the market consumption data set 308 to determine the market opportunity 214 such as the example return on investment opportunity 1014. For example, the market opportunity identifier 310 of the illustrated example analyzes the market demand data set 304 to determine geographic locations with the highest demand for the specified healthcare product of interest. Further, the example market opportunity identifier 310 analyzes the market availability data set 306 and the market consumption data set 308 to determine the geographic locations with the lowest availability and highest potential for consumption of the healthcare product. The example return on investment opportunity 1014 identifies the matched geographic locations from the analysis of each of the data sets 304, 306 and 308 as the geographic locations with the highest potential return on the marketing investment dollars.

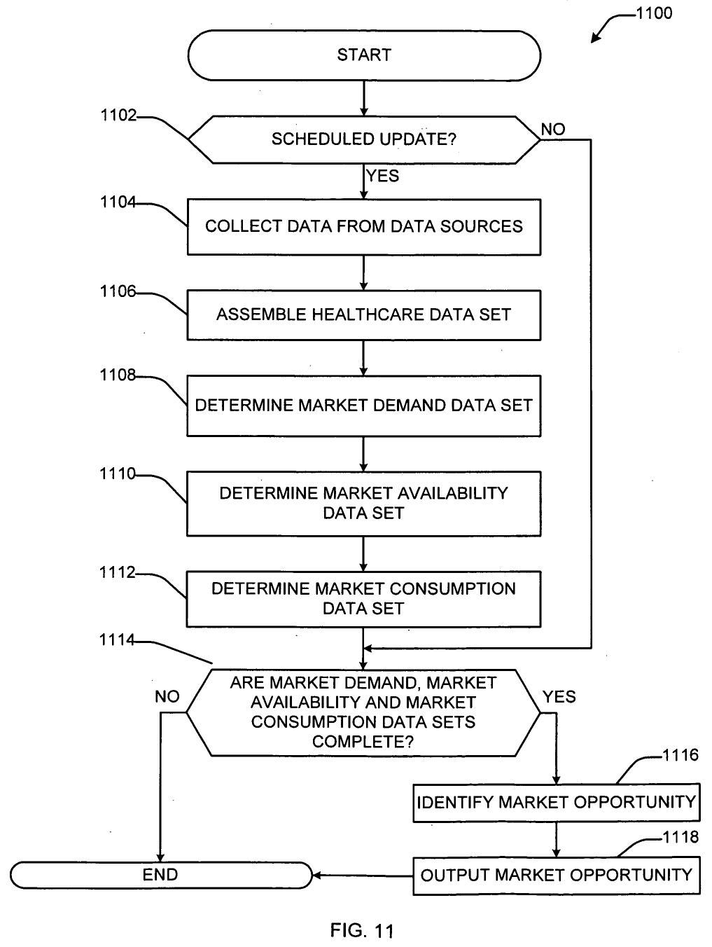

Flowcharts representative of example processes that may be executed to implement the healthcare market analyzer 212 of FIGS. 2-5, 7 and 8 are shown in FIGS. 11 through 15. In these examples, the operations represented by each flowchart may comprise one or more programs for execution by: (a) a processor, such as the processor 2302 shown in the example processor system 2300 discussed below in connection with FIG. 23, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 2302, but the entire program or programs and/or portions thereof could alternatively be executed by a device other than the processor 2302 and/or embodied in firmware or dedicated hardware (e.g., implemented by an application specific integrated circuit (ASIC), a programmable logic device (PLD), a field programmable logic device (FPLD), discrete logic, etc.). For example, any or all of the data set generator 302, the market demand data set 304, the market availability data set 306, the market consumption data set 308, the market opportunity identifier 310, the scheduler 402, the collector 404, the assembler 406, the healthcare data set 408, the market demand analyzer 410, the market availability analyzer 412, the market consumption analyzer 414, the assembler 502, the organizer 504, the estimator 506, the generator 508, the assembler 702, the estimator 704, the geographic linker 706, the generator 708, the collector 802, the analyzer 804, the geographic linker 806, the predictor 808, the projector 812, the generator 814, the requester 902, the determiner 904, the opportunity calculator 906, and the opportunity generator 908 could be implemented by any combination of software, hardware, and/or firmware. In addition, one or more of the operations represented by the flowcharts of FIGS. 11 through 15 may be implemented manually.

Further, although the example processes are described with reference to the flowcharts illustrated in FIGS. 11 through 15, many other techniques for implementing the example methods and apparatus described herein may alternatively be used. For example, with reference to the flowcharts illustrated in FIGS. 11 through 15, the order of execution of the blocks may be changed, and/or some of the blocks described may be changed, eliminated, combined and/or subdivided into multiple blocks.

An example process 1100 that may be executed to implement healthcare market analyzer 212 of FIGS. 2-5 and 7-9 is represented by the flowchart shown in FIG. 11. In this example process, the operations analyze data associated with the use of healthcare products within a healthcare market 100 (FIG. 1) gathered from a plurality of sources (e.g., the healthcare consumer 104, the healthcare provider 106, the retailer 108 and/or the payor 110) to generate one or more data sets (e.g., a market demand data set 304, a market availability data set 306 and/or a market consumption data set 308 of FIG. 3) and/or to generate one or more marketing opportunities 214 (FIG. 2) (e.g., the patient behavior opportunity 1002, the investment prioritization opportunity 1004, the market location opportunity 1006, the communication opportunity 1008, the forecasting opportunity 1010, the formulary development opportunity 1012 and/or the return on investment opportunity 1014 of FIG. 10). While the example process 1100 is shown to be by the example healthcare market analyzer 212 of FIG. 2, the process may be performed anywhere the collected data associated with the healthcare market 100 may be accessed. For example, the example process 1100 may also be implemented where one or more of the components of the example healthcare market analyzer 212 represented in FIG. 3 (e.g., the data set generator 302, the market demand data set 304, the market availability data set 306, the market consumption data set 308 and/or market opportunity identifier 310) are implemented on different processor systems 2300 (FIG. 23). The example operations may be executed at periodic or aperiodic intervals, based on an occurrence of a predetermined event, etc., or any combination thereof.

The example process 1100 of FIG. 11 initially causes the example scheduler 402 (FIG. 4) of the healthcare market analyzer 212 to determine whether a scheduled update event (e.g., an update scheduled for every Friday evening at 11:00 p.m.) and/or an aperiodic update event (e.g., an update of data within one or more of the example consumer behavior data set 202, the consumer profiles data set 206, the healthcare products data set 208, and/or the healthcare statistic data set 210) has occurred (block 1102). If the scheduler 402 determines that an update event has not occurred (block 1102), then the healthcare market analyzer 212 examines whether the market demand data set 304, the market availability data set 306 and the market consumption data set 308 have been determined by the demand analyzer 410, the availability analyzer 412 and the consumption analyzer 414, respectively (block 1114). If the scheduler 402 determines that an update event has occurred (block 1102), then the scheduler 402 triggers the collector 404 to collect data from one or more of the example consumer behavior data set 202, the example consumer profiles data set 206, the example healthcare products data set 208, and/or the example healthcare statistic data set 210 (block 1104). Once the data is collected by the collector 404, the assembler 406 generates the healthcare data set 408 (block 11106).

Next, the example demand analyzer 410 of the healthcare market analyzer 212 determines the market demand data set 304 (block 1108). Next, the example availability analyzer 412 analyzes the healthcare data set 408 to determine the example market availability data set 306 (block 1110). Further, the example consumption analyzer 414 analyzes the healthcare data set 408 to determine the example market consumption data set 308 (block 1112). Next, the market opportunity identifier 310 checks whether the data set analyzers 410-414 have completed the scheduled update of the market demand data set 304, market availability data set 306 and/or the market consumption data set 308 or if no update was scheduled (block 1102), the market opportunity identifier 310 checks if the data sets 304-308 are complete (block 1114). If the market opportunity identifier 310 determines the data sets 304-308 are not complete (block 1114), the example process 1100 terminates. If the market opportunity identifier 310 determines that one or more of the data sets 304-308 are complete (block 1114), the market opportunity identifier 310 identifies the marketing opportunity 214 based on data contained in one or more of the market demand data set 304, the market availability data set 306 and the market consumption data set 308 (block 1116) and outputs the identified marketing opportunity to a user (block 1118).

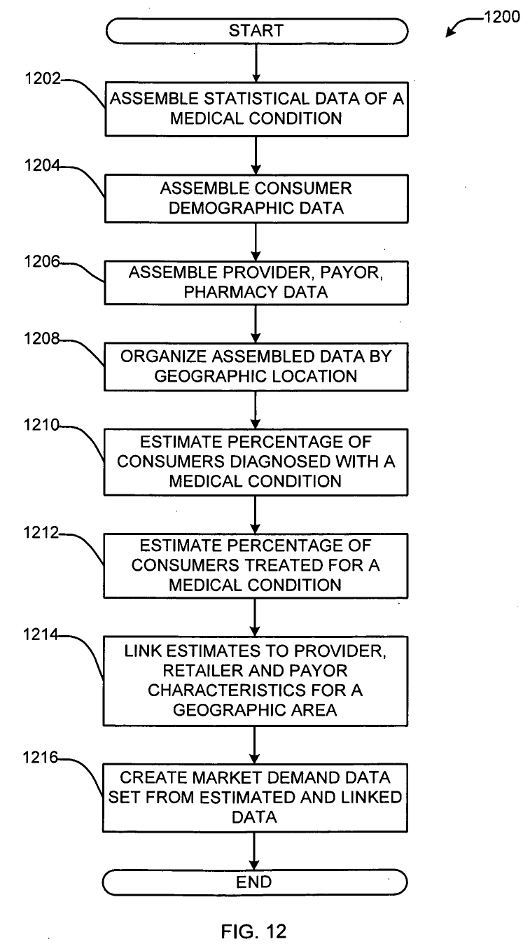

An example process 1200 that may be used to implement the example demand analyzer 410 of FIGS. 4 and 7 and/or used to implement block 1106 of FIG. 11 to determine the example market demand data set 304 is represented by the flowchart depicted in FIG. 12. In the example process 1200, the demand analyzer 410 analyzes a study corresponding to a healthcare need (e.g., a study describing mortality rates for a disease) and data describing the healthcare market 100 of FIG. 1 including data related to the consumer 104, the provider 106, the retailer 108 and the payor 110 (e.g., demographics, location, treatment preferences, claims information, formulary data, etc.) to generate the market demand data set 304. While the example operations are shown to be implemented within the example data set generator 302, the operations may be implemented anywhere the healthcare data set 408 may be accessed. Further, the example operations may be executed at periodic or aperiodic intervals, based on an occurrence of a predetermined event, etc., or any combination thereof.

The example process 1200 of FIG. 12 begins when the example assembler 702 of the demand analyzer 410 assembles statistical data corresponding to one or more healthcare studies (block 1202). For example, the assembler 702 may gather data from one study corresponding to hypertension prevalence for consumers 104 over the age of 65 for residents of a state and data corresponding to hypertension mortality rates for the same state. Next, the assembler 702 gathers consumer demographic data from the healthcare data set 408 of FIG. 4 (block 1204). Additionally, the example assembler 702 collects provider data, payor data and/or retailer data from the healthcare data set 408 (block 1206). Once the data is assembled, the data (e.g., the statistics data, the consumer demographic data, the provider data, the payor data and/or the retailer data) is organized according to relatively small geographic locations (e.g., a local zip code) to facilitate operations performed by the estimator 704 (block 1208).

Next, in this example implementation, the estimator 704 estimates a percentage of consumers 104 diagnosed with a medical condition for a geographic location by analyzing the healthcare statistics data along with the consumer demographic data (block 1210). For example, the estimator 704 may analyze the consumer demographic data with the above-mentioned hypertension prevalence and mortality studies to determine a first healthcare need characteristic (e.g., a percentage of consumers 104 within the state that are diagnosed having the healthcare need). Next, the example estimator 704 analyzes the first estimated healthcare need characteristic, the provider data, retailer data and/or payor data to estimate a second healthcare need characteristic (e.g., a percentage of consumers 104 receiving treatment for the healthcare need) (block 1212). For example, the estimator 704 may analyze data associated with healthcare claims for prescriptions for healthcare products used in hypertension treatments to estimate a percentage of consumers 104 that are receiving treatment for hypertension. The geographic linker 706 analyzes the first and second estimated healthcare need characteristics along with the consumer demographics data, the payor data, provider data and retailer data to link actual patient usage of a healthcare product to the estimated healthcare need characteristics (block 1214). The generator 708 then compiles the estimated and linked characteristics along with the data within the healthcare data set 408 into the market demand data set 304 (block 1216).

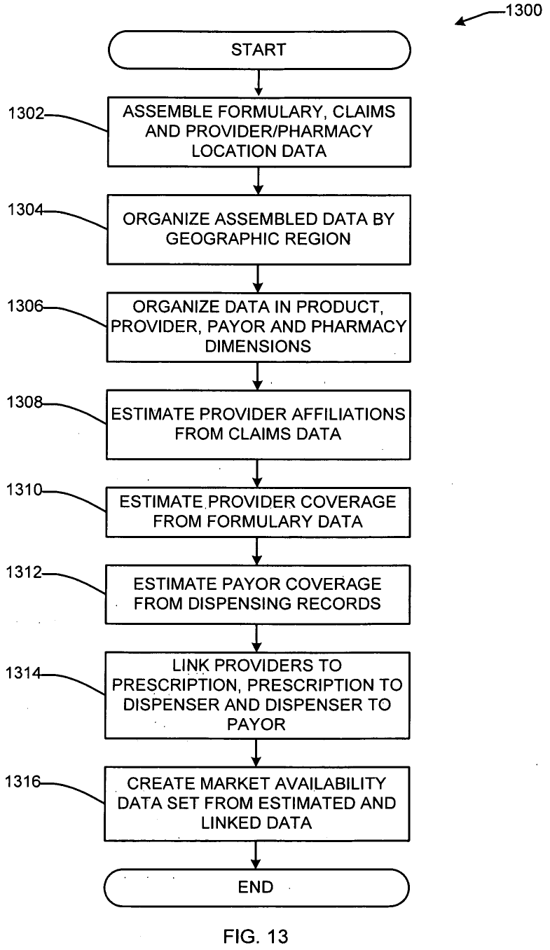

An example process 1300 that may be used to implement the example availability analyzer 412 of FIGS. 4 and 5 and/or used to implement block 1108 of FIG. 11 to determine the example market availability data set 306 is represented by the flowchart depicted in FIG. 13. In the example process 1300, the availability analyzer 412 analyzes the data in the example healthcare data set 408 to derive estimated provider characteristics and/or payor characteristics and determine the market availability data set 306 in terms of the availability of a healthcare product by price across provider affiliations (e.g., a healthcare consumer relationship or membership in healthcare networks), payor formularies, geographic locations and/or consumer segments. While the example operations are shown to be implemented within the example data set generator 302, the operations may be implemented anywhere the healthcare data set 408 may be accessed. Further, the example operations may be executed at periodic or aperiodic intervals, based on an occurrence of a predetermined event, etc., or any combination thereof.

The example process 1300 of FIG. 13 begins when the example assembler 502 of the availability analyzer 412 gathers data corresponding to the use of a healthcare product from the healthcare data set 408 for a geographic area of interest, including, for example, formulary data, claims data, retailer location data and/or provider location data (block 1302). For example, the example operations may cause the example assembler 502 to gather a government data record, a syndicated formulary database, a syndicated claims data record, and/or retailer characteristics. Next, the organizer 504 organizes the data gathered by the assembler 502 by geographic location, for example, the data is organized according to region defined by an extended zip code (block 1304). The organizer 504 organizes the data in a multidimensional matrix (e.g., the example data structure 600 of FIG. 6) into dimensions such as, a healthcare product dimension, a provider dimension, a payor dimension a retailer dimension and a price dimension (block 1306).

Next, the estimator 506 of the illustrated example estimates a provider affiliation characteristic by analyzing the claims data over a geographic area (block 1308). For example, the provider affiliation characteristic may be determined by analyzing claims data corresponding to claims submitted to a payor 110 associated with healthcare treatments and/or prescriptions for healthcare products within a geographic area. The example estimator 506 then estimates a provider coverage characteristic based on formulary data associated with a payor 110 (block 1310). For example, an estimated payor coverage characteristic may correspond to a percentage of time that a healthcare provider 106 may prescribe a particular healthcare product and be determined by analyzing formulary lists, formulary tiers and provider affiliations. Next, the example estimator 506 estimates a payor coverage characteristic by analyzing dispensing records (block 1312). For example, the example estimator 506 may analyze the dispensing records from a retailer 108 to determine a usage pattern for healthcare consumers 104 and then associate the dispensing records to a payor 110 through an analysis of claims data for a geographic area associated with the retailer 108.

Next the generator 508 links the provider 106 to prescriptions, prescriptions to a retail dispensing record and the retail dispensing record to a payor 110 by analyzing the payor coverage characteristic (block 1314). For example, the generator 508 may analyze the prescription claims data and the payor coverage characteristic to determine, for example, a percentage of dispensed healthcare products that is associated with a payor 110. Further, the dispensing records and the prescription claim data submitted to a payor 110 may further be analyzed to link the retail dispensing record to a prescription (block 1314). Additionally, the prescription claim record and the provider claim records may then be analyzed to link a healthcare provider 106 to a prescription (block 1314). Finally, the example generator 508 generates the market availability data set 306 by compiling the fact-based data within the healthcare data set 408 with the estimates generated by the estimator 506 into the multidimensional matrix represented by the data structure 600 of FIG. 6 (block 1316).

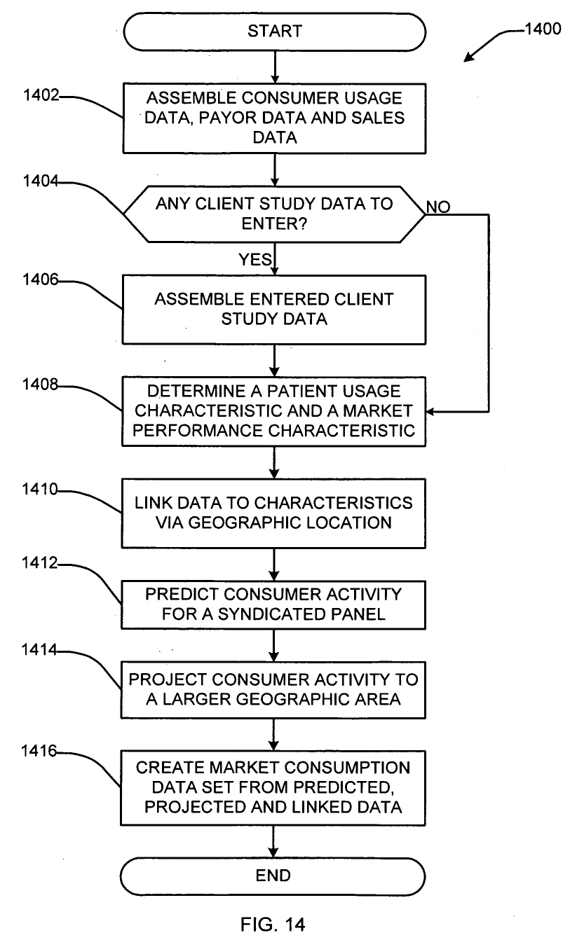

An example process 1400 that may be used to implement the example consumption analyzer 414 of FIGS. 4 and 8 and/or used to implement block 1110 of FIG. 11 to determine the example market consumption data set 308 is represented by the flowchart depicted in FIG. 14. In the example process 1400, the consumption analyzer 414 analyzes the data in the example healthcare data set 408 to determine the market consumption data set 308 in terms of behavior of healthcare consumers 104 by examining aggregate retail sales (e.g., OTC product sales and/or prescription product sales) and the use of healthcare products by individual healthcare consumers 104. While the example operations are described as being implemented within the example data set generator 302, the operations may be implemented anywhere the healthcare data set 408 may be accessed. Further, the example operations may be executed at periodic or aperiodic intervals, based on an occurrence of a predetermined event, etc., or any combination thereof.

The example process 1400 of FIG. 14 begins when the example collector 802 of FIG. 8 assembles data associated with the use of a healthcare product by healthcare consumers 104 having a healthcare need from the healthcare data set 408 (block 1402). For example, the collector 802 collects data associated with the use of a healthcare product that was generated by a consumer panelist, generated from payor claims data and/or retail data associated with sales of OTC and prescription healthcare products. Next, the example collector 802 determines whether a sufferer panel associated with a healthcare need is to be collected by, for example, prompting a user to enter the data (block 1404). If the collector 802 determines that no sufferer panel data is to be collected (block 1404), then control advances to block 1408. If the collector 802 determines that sufferer panel data is available for collection (block 1404), the sufferer panel data is collected (block 1406). The example analyzer 804 of the example consumption analyzer 414 then analyzes the data collected by the collector 802 to determine a patient usage characteristic and a market performance characteristic associated with a healthcare product (block 1408). For example, the analyzer 804 may analyze the claims and purchasing records associated with a healthcare product to determine a patient usage characteristic corresponding to the consumer's 104 usage of the prescription healthcare product. Additionally, the market usage characteristic determined by the analyzer 804 may be prescription loss characteristic corresponding to the number of prescriptions for the healthcare product written by healthcare providers 106 that are not filled, not refilled or substituted for a competing product.

Once the example analyzer 804 determines one or more patient usage and/or market performance characteristics associated with the healthcare product of interest, the example geographic linker 806 links the patient usage characteristic(s) to the market performance characteristic(s) and/or characteristics of the provider 106, retailer 108 and/or payor 110 (e.g., a payor coverage area, a formulary coverage statistic, a provider coverage area, etc.) (block 1410). For example, the geographic linker 806 links the characteristics by associating the patient usage characteristic and/or market performance characteristic to the geographic location corresponding to the healthcare consumer 104 and/or retailer 108.

Next, the example predictor 808 analyzes the patient and/or market performance characteristics with actual prescription dispensing and/or claims data to predict prescription behavior for a known population (block 1412). For example, the predictor 808 uses a patient usage characteristic and/or market performance characteristic based on data collected from a sufferer panel. Then the example predictor 808 predicts prescription behavior for a population represented by a syndicated panel (e.g., a Homescan® panel) based on a matched sample overlap with the sufferer panel. Once the predictor 808 predicts a characteristic associated with the syndicated panel, such as a prescription behavior, the example projector 812 projects the predicted characteristic to a larger population (block 1414). For example, a syndicated panel may be chosen so that the panelists are representative of healthcare consumers 104 as a whole to enable data determined from the panel to be projected to a larger population. Next, the generator 814 of the example consumption analyzer 414 then generates the market consumption data set 308 by compiling the fact based data collected from the healthcare data set 408, the determined characteristic(s) from the analyzer 804, the predictions from the example predictor 808 and projections from the projector 812 (block 1416).

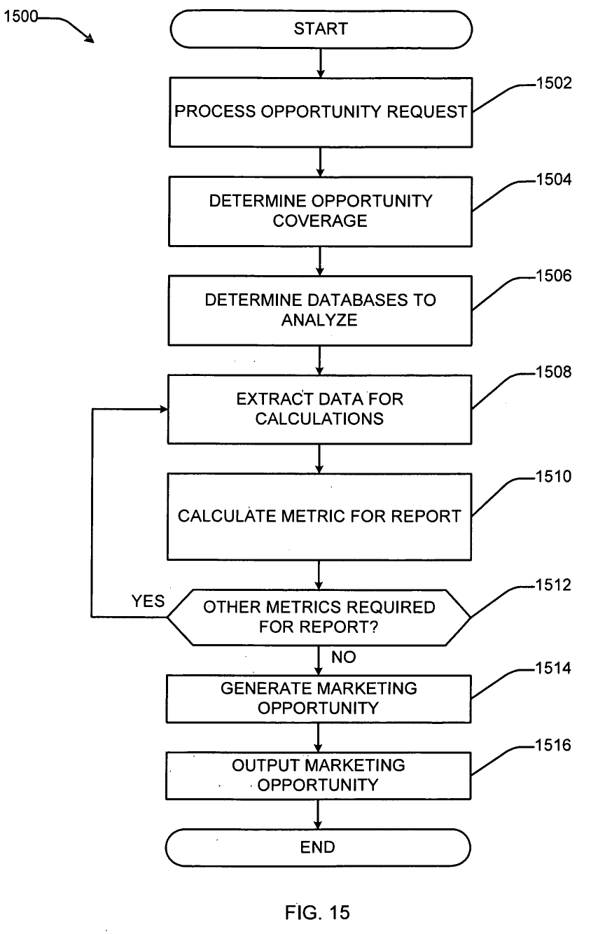

An example process 1500 that may be used to implement the example market opportunity identifier 310 of FIGS. 3 and 9 and/or used to implement block 1114 of FIG. 11 to determine the example marketing opportunities 214 (FIG. 2) is represented by the flowchart depicted in FIG. 15. In the example process 1500, the market opportunity identifier 310 analyzes the data in the example market demand data set 304, the market availability data set 306 and/or the market consumption data set 308 to identify the marketing opportunities 214 for a healthcare product. While the example operations are shown to be implemented within the example healthcare market analyzer 212 (FIG. 2), the operations may be implemented anywhere one or more of the example market demand data set 304, the market availability data set 306 and the market consumption data set 308 may be accessed. Further, the example operations may be executed at periodic or aperiodic intervals, based on an occurrence of a predetermined event, etc., or any combination thereof.

The example process 1500 of FIG. 15 begins when the requestor 902 of the example market opportunity identifier 310 of FIGS. 3 and 9 receives a request for a marketing opportunity 214 (block 1502). The example request may be entered by a user via an input device 2318 of FIG. 23 (e.g., a keyboard, touch screen, etc.) and/or from predetermined criteria stored in a memory (e.g., the example random access memory 2308, the example read only memory 2310, etc.). Next, the example determiner 904 determines the geographic region and/or consumer segment corresponding to the requested marketing opportunity 214 (block 1504). For example, the marketing opportunity 214 may be requested for a sales territory of a healthcare product manufacturer 102 or for a particular consumer demographic segment in a geographic area (e.g., healthcare consumers 104 over the age of 40 living in Cook County, Ill.). Next, the example determiner 904 determines one or more of the example market demand data set 304, the market availability data set 306 and/or the market consumption data set 308 to analyze to create the requested marketing opportunity 214 (block 1506).

Next, the opportunity calculator 906 of the illustrated example analyzes data contained in the data sets that were identified by the determiner 904 and extracts data useful in identifying the requested marketing opportunity 214 (block 1508). The example opportunity calculator 906 then calculates metrics from the identified data sets that are useful in creating the marketing opportunity 214 (block 1510). For example, the opportunity calculator 906 may calculate an average copay cost for a healthcare product. The opportunity calculator 906 then determines whether another metric is to be calculated to generate the requested marketing opportunity (block 1512). If another metric is to be calculated (block 1512), then control returns to block 1508 to extract further data from the data sets 304, 306 and/or 308 to use in determining another metric. If no further metric is needed to calculate the marketing opportunity (block 1512), the example opportunity generator 908 generates the marketing opportunity (block 1514) and outputs the marketing opportunity to a user (block 1516). For example, the example opportunity generator 908 may analyze copay costs associated with competing healthcare products within a state (e.g., Florida) that were calculated by the opportunity calculator 906 in identifying and/or outputting the marketing opportunity 214 that targets marketing efforts in counties where the healthcare product of interest has a pricing advantage.

FIGS. 16A and 16B depict data contained in and/or calculated from, for example, the market availability data set 306 to illustrate an example availability metric for a healthcare product based on average consumer copay costs. FIG. 16A is an example table arranged counties of Florida (e.g., Broward, Palm Beach, Liberty, etc.) and containing data reflecting the weighted average copay costs for two competing healthcare products (e.g., drug A 1602 and drug B 1604). The table also contains a calculated metric (e.g., the drug index 1606) useful in comparing the copay costs for two or more competing healthcare products, in this example drug A 1602 and drug B 1604.

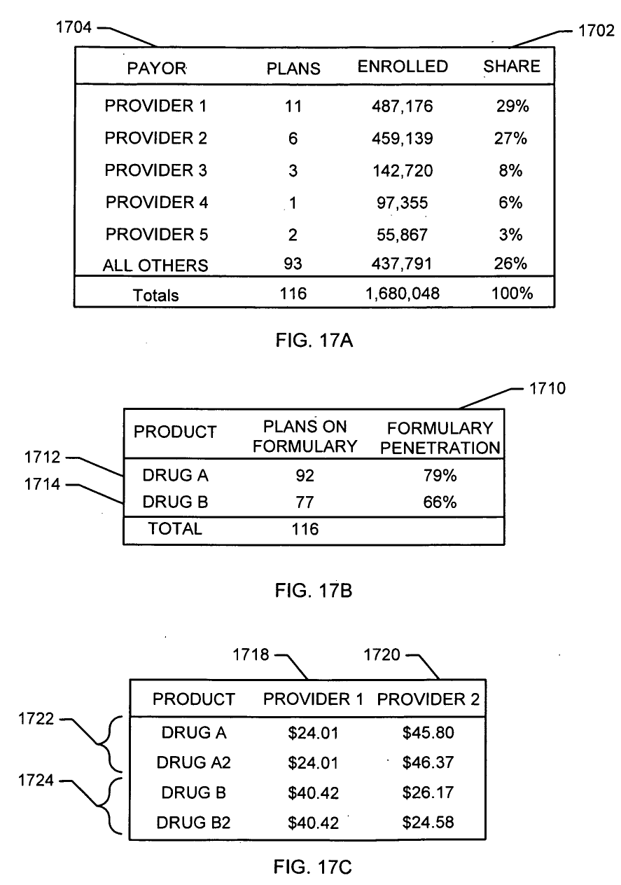

The drug index 1606 of the illustrated example is shown to be calculated based on the average copay costs of two healthcare products of interest (e.g., drug index=(average copay cost of a first healthcare product)/(the average copay cost of a second healthcare product)). For example, the drug index of FIGS. 16A-B are calculated by dividing the average copay cost of drug A 1602 by the average copay cost for drug B 1604 for each county in Florida. The average copay costs of this example represent a weighted average of copay costs within the county based at least, in part, on the formulary data, payor data and copay cost data, an example of which is illustrated below in FIGS. 17A-17C.

The example drug index 1606 represents a metric useful in comparing healthcare product costs of healthcare consumers 104 reflecting the availability of the healthcare product. The lower drug index 1606 values reflect a greater availability based on copay cost because consumers 104 are more likely to purchase the lowest cost healthcare product among competing products. For example, in Broward county 1614, the average copay cost of drug A 1602 is $40.99 as compared to the average copay cost of $20.77 in Liberty county 1616. Further, the calculated drug index 1606 in Broward county 1614 is 1.48 (e.g., drug index=$40.99/$27.71) and in Liberty county 1616, the drug index is 0.76 (e.g., drug index=$29.77/$39.15). Therefore, drug A 1602 may be said to have a greater availability in Liberty county 1616 and drug B 1604 has a greater availability in Broward county 1614.

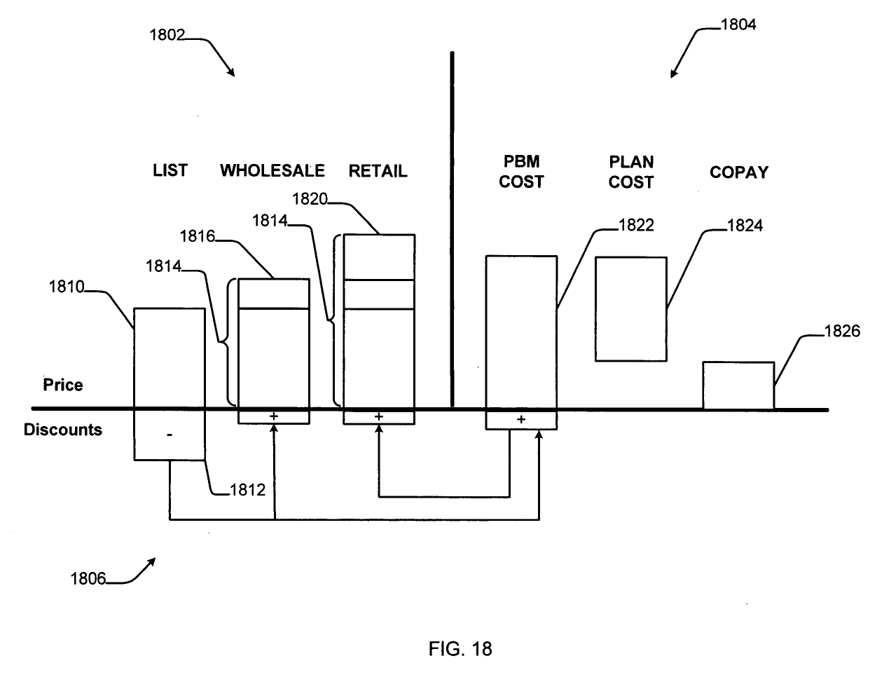

FIGS. 17A, 17B and 17C are representations of example data that may be contained in the example market availability data set 306 and useful to determine the marketing opportunity 214, for example, based on price competitiveness in a given market 100. Factors useful in generating the price competitiveness marketing opportunity 214 may include plan participation (FIG. 17A), formulary penetration (FIG. 17B), and/or formulary copay tier (FIG. 17C). As shown below in conjunction with FIG. 18, costs associated with healthcare products correspond to many factors in addition to manufacturer list price.

FIG. 17A is a table representative of healthcare consumer participation in healthcare plans available in a state such as Florida. The table in FIG. 17A contains data representing market share 1702 (e.g., the percentage of total enrolled healthcare consumers 104 participating in plans offered by the payor 110) for the top five payors 110 providing healthcare coverage in Florida. The market share 1702 associated with the payors 110 is useful in creating an example marketing opportunity 214 because healthcare consumers 104 purchase healthcare products based not only on a need, but also by the price and/or copay cost determined by the healthcare consumer's 104 healthcare plan.

In the illustrated example, one hundred and sixteen healthcare plans are available to healthcare consumers 104 in the state of Florida. Twenty-three of the healthcare plans are offered through the top five payors 1704 (e.g., healthcare provider 1, healthcare provider 2, etc.) and account for 74% of the market share 1706. Further, the top two plans, provider 1 and provider 2, collectively cover 56% of the healthcare consumers 104 in the market for health insurance. Therefore, for example, the marketing opportunity identifier 310 may analyze the market availability data set 306 to identify a marketing opportunity 214 for a healthcare product by analyzing data associated with one or more of the top five healthcare plans 1704 for the state of Florida.

In FIG. 17B, an example formulary metric 1710 (e.g., a formulary penetration metric for competing healthcare products) useful in determining the availability of a healthcare product to consumers 104 is shown. As noted above, price is an important factor influencing purchasing decisions of the healthcare consumer 104, which in turn depends on the copay costs of healthcare products determined by the payor 110 through formulary lists. In FIG. 17B, the number of healthcare plans utilizing formulary lists containing two competing products, drug A 1712 and drug B 1714, are compared to determine the example formulary metric 1710. Drug A 1712 is shown to be on formularies utilized by 79% of the available healthcare plans, whereas drug B 1714 is on formularies utilized by 66% of the healthcare plans in Florida. For example, the example formulary penetration metric data may be extracted from the market availability data set 306 (FIG. 3) by the market opportunity identifier 310 to determine a marketing opportunity 214 targeting marketing efforts to increase formulary penetration for a product.

FIG. 17C demonstrates the effect that formulary tiers have on the price competitiveness of healthcare products through a formulary tier metric. For example, a formulary may categorize healthcare products according to tiers to determine the copay responsibility of the healthcare consumer 104. A tier 1 may include preferred healthcare products, such as generic drugs, and have the lowest copay level. A mid-range formulary tier, tier 2, may contain preferred brand-name healthcare products that have higher copays than tier 1 products. A third formulary tier may include other healthcare products that are not included on the preferred product list of tier 2, and have copay costs higher that either tier 1 or tier 2 products. Some healthcare plans also include a tier for specialty drugs where the copay costs may be up to 33% of the retail list price.

In FIG. 17C, the formulary copay tiers for example healthcare products may be inferred from the data in the chart for two example payors 110, provider 1 1718 and provider 2 1720. For example, provider 1 1718 plans have copay costs for the drug A family of products 1722 that are lower than the copay costs for the drug B family of products 1724 (e.g., $24.01 versus $40.42, respectively). Drug A may therefore be inferred to be on a lower formulary tier than drug B for the healthcare plans offered through provider 1. The pricing structure is reversed for provider 2 1720, where drug B may be inferred to be on a lower formulary tier than drug A for the plans offered through provider 2. The determined formulary tier metric may be used by the example market opportunity identifier 310 to identify a marketing opportunity 214 for formulary development.

FIG. 18 is an example representation of a price model that may be used by the market opportunity identifier 310 to identify pricing elements from data in the example market availability data set 306. The pricing elements may be calculated for geographic locations (e.g., a local zip code, a sales territory, etc.) or consumer segments (e.g., consumers 104 over the age of 65) to facilitate the generation of marketing opportunities 214.

The pricing elements may include a selling component 1802, a paying component 1804 associated with purchased healthcare product and/or a discount component 1806 (e.g., a discount, rebate, etc.). The selling 1802, paying 1804 and/or discount 1806 components provide a more accurate representation of healthcare product costs than manufacturer list price which, in turn, allows the market opportunity identifier 310 to identify the marketing opportunities 214 more accurately.

The healthcare product manufacturer 102 (FIG. 1) determines a list price 1810 for a healthcare product and discounts and/or rebates 1812 to encourage a wholesaler, the retailer 108 and/or the pharmacy benefit manager to promote the use of the healthcare product. A wholesale price 1814 includes the manufacturer list price 1810 and a first added margin 1816. Similarly, the retail list 1818 price includes the wholesale price 1814 plus a second margin 1820. A healthcare product manufacturer 102 may provide the wholesaler a discount and/or rebate to allow the wholesaler to reduce the wholesale price 1814 of the product which, in turn, reduces the retail price 1818.

In general, the pharmacy benefit manager negotiates with a retailer 108 to set the cost of the healthcare product 1822. Then, the payor 110 and/or the pharmacy benefit manager determine the formulary tier associated with the healthcare product. The formulary tier then determines a payor cost portion 1824 and a consumer copay cost 1826. The healthcare product manufacturer 102 has a direct of indirect influence on the pricing and/or cost negotiations by providing discounts and/or rebates to any one or more of the wholesaler, retailer 108, and/or pharmacy benefit manager. The pharmacy benefit manager may use any discount and/or rebate received from the healthcare manufacturer 102 in the pricing negotiations with the retailer 108. The healthcare product manufacturer 102 may further provide a discount to a healthcare consumer 104, for example in a coupon for the healthcare product (not illustrated).

FIGS. 19 and 20 are example healthcare studies that may be provided by a government 112 agency and utilized by the demand analyzer 410 (FIGS. 4 and 7) in determining the example market demand data set 304 of FIG. 3. FIG. 19 represents the hypertension prevalence rates of a demographic group (e.g., people age 65 and over) in Florida and reported by county. As can be seen in FIG. 19, the hypertension prevalence rates vary significantly by geographic regions (e.g., counties) and are driven by the underlying demographics of the population. For example, Collier county 1902 has one of the top-ten hypertension prevalence rates for the state of Florida at 19.1%. Conversely, Leon county 1904 has one of the lowest ten-hypertension prevalence rates in the state at 7.1%. Previously, market opportunities 214 may have been generated by marketing research companies only based on studies substantially similar to the one illustrated in FIG. 19.

FIG. 20 is an example hypertension mortality rate study representing a mortality rate in terms of population (e.g., the mortality rate per 100,000 people). For example, Collier county 2002 has one of the lowest hypertension mortality rates of the state at 58.1 per 100,000 persons. Conversely, Leon county 2004 has one of the highest hypertension mortality rates at 193.2 per 100,000 persons.

In the illustrated example, the demand analyzer 410 analyzes the data in one or more healthcare studies (e.g., the studies shown in FIGS. 19 and 20) over a geographic area, such as Florida, to determine characteristics associated with the population and useful in determining the market demand data set 304 and/or marketing opportunities 214. For example, by comparing the data in the studies of FIGS. 19 and 20, the demand analyzer 410 may determine a characteristic of the population showing that the hypertension mortality rates inversely correlate to hypertension prevalence. The determined characteristic further indicates differences in access to healthcare products and treatment opportunities for the underlying population. Further, the market opportunity identifier 310 may utilize this data to identify a marketing opportunity 214 useful to a healthcare manufacturer 102 in focusing marketing efforts specifically designed for a geographic area. For example, the studies of FIGS. 19 and 20 may be analyzed to show that, in one geographic area, 45% of the population with the healthcare condition is not diagnosed and 42% is diagnosed but not treated. Further, the data may show that, for the treated healthcare consumers, 70% are treated but not at goal and/or only 9% are treated optimally.

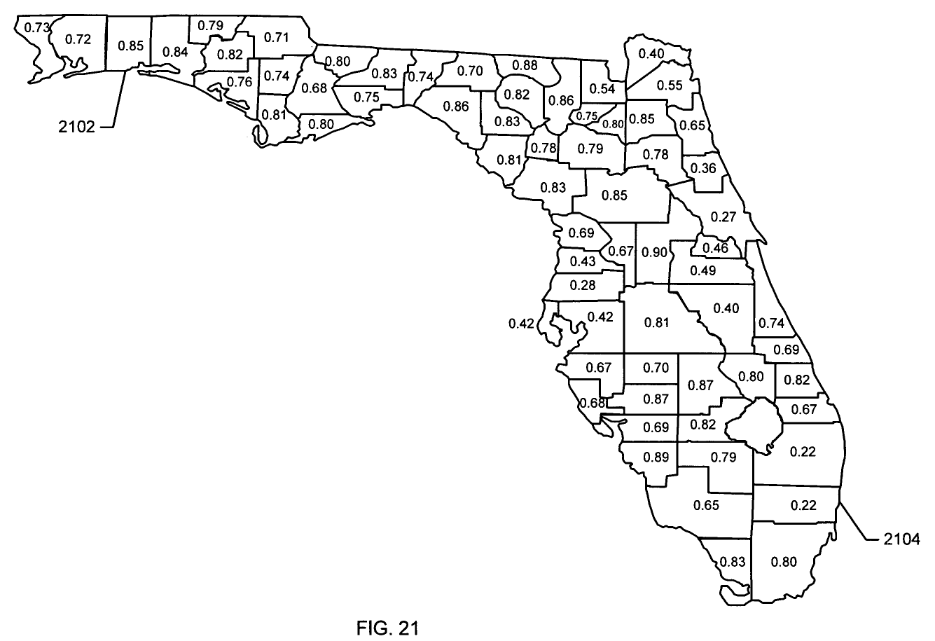

FIG. 21 is a representation of example data illustrating a marketing opportunity 214 (FIG. 2) created by the example market opportunity identifier 310 (FIG. 3) by analyzing data in the market demand data set 304, the market availability data set 306 and market consumption data set 308. The market opportunity identifier 310 may create a metric useful in determining a marketing opportunity for a healthcare product (e.g., a drug utilization ratio), for example, by analyzing data from the market demand data set 304 and the market consumption data set 308. For example, the market opportunity identifier 310 may extract the actual number of prescriptions filled for a healthcare product from the market consumption data set 308 and a value representative of an estimated potential for prescriptions for the healthcare product from the market demand data set 304.

The example drug utilization ratio may be calculated for a geographic area (e.g., a county, a state, a sales territory, etc.) based on the formula: drug utilization ratio=(actual prescriptions)÷(estimated prescription potential). For example, an estimated prescription potential for a state may be calculated based on (1) the number of enrolled healthcare consumers 104 having a condition (e.g., calculated from prevalence and access data from the market demand data set 304), (2) the average number of prescriptions written per member of a health plan and (3) from a market share associated with a healthcare product. For example, an estimated prescription potential for drug A in Florida may be calculated to be 1,068,323, and the actual number of prescriptions written were 604,319. The resulting utilization ratio for drug A is 0.57 (604,319÷.1,068,323). The unrealized market potential of this example in Florida (e.g., estimated potential prescriptions−actual prescriptions) is 464,004 prescriptions having a market value of $30.7 million.

Further, the data may further analyzed for smaller geographic locations (e.g., a county) to better identify marketing opportunities 214 to target the unrealized potential market. For example, in Okaloosa county 2102, the utilization ratio is 0.85, representing 85% of the estimated potential scripts were written for drug A. However, in Broward county 2104, only 22% of the estimated prescriptions were written.

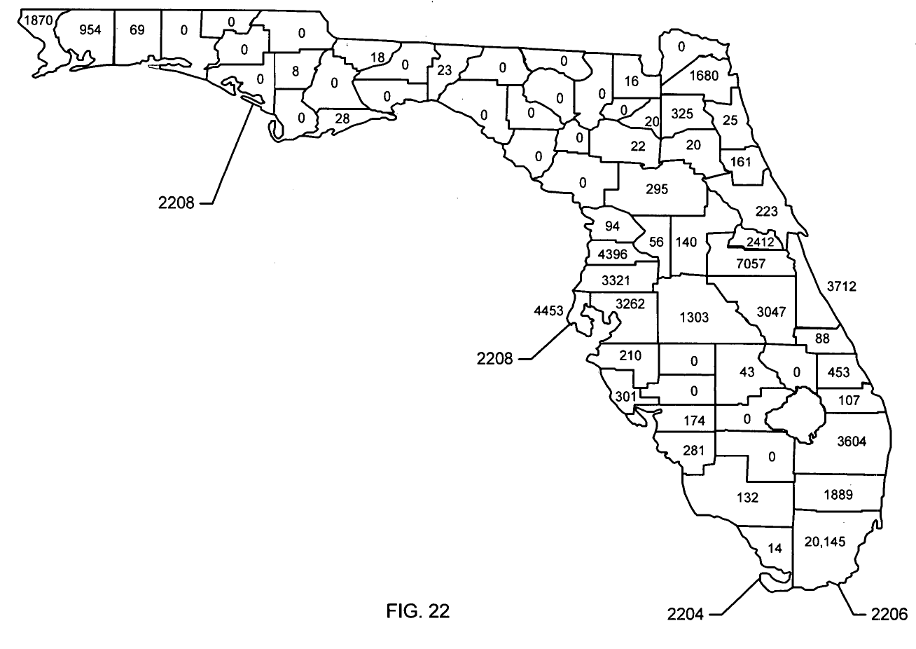

FIG. 22 is a representation of example data illustrating another marketing opportunity 214 that may be created by the market opportunity identifier 310 by analyzing data in the market demand data set 304, the market availability data set 306 and market consumption data set 308. A healthcare consumer's access to a healthcare product through prescriptions may be limited by formulary restrictions such as, a healthcare product belonging to the highest tier or not included on the formulary. The healthcare consumer's limited access to the product results in, for example, lost prescriptions and a corresponding loss in sales for the product. The example market opportunity identifier 310 may use this information to generate an example market opportunity 214 for formulary development to remove the restrictions on the consumer's access to the product, thus increasing sales. In the illustrated example, counties with little or no identified restrictions (e.g., Bay county 2202, Monroe county 2204) can be separated from the counties with more identified lost opportunities (e.g., Miami-Dade 2206, Pinellas 2208, etc.). The market opportunity identifier 310 may utilize this information in identifying an opportunity to target formulary development in the counties with large numbers of lost opportunities, such as Pinellas 2208.

FIG. 23 is a schematic diagram of an example processor platform 2300 that may be used and/or programmed to implement all or a portion of any or all of the example operations of FIGS. 11-15. For example, one or more general-purpose processors, microcontrollers, etc can implement the processor platform 2300. The example processor platform 2300 or a platform similar thereto, may be used to implement the example market segmentation system 200. The processor platform 2300 of the example of FIG. 23 includes at least one general-purpose programmable processor 2300. The processor 2302 executes coded instructions 2304 and/or 2306 present in main memory of the processor 2302 (e.g., within a RAM 2308 and/or a ROM 2310). The processor 2302 may be any type of processing unit, such as a processor or a microcontroller. The processor 2302 may execute, among other things, the example methods and apparatus described herein.

The processor 2302 is in communication with the main memory (including a RAM 2308 and/or a ROM 2310) via a bus 2312. The RAM 2308 may be implemented by dynamic random-access memory (DRAM), synchronous dynamic random-access memory (SDRAM), and/or any other type of RAM device, and the ROM 2310 may be implemented by flash memory and/or any other desired type of memory device. A memory controller 2314 may control access to the memory 2308 and the memory 2310.

The processor platform 2302 also includes an interface circuit 2316. The interface circuit 2316 may be implemented by any type of interface standard, such as an external memory interface, serial port, general purpose input/output, etc. One or more input devices 2318 and one or more output devices 2320 are connected to the interface circuit 2316.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A computer implemented method of identifying a market opportunity for a healthcare product, comprising:
obtaining a first data set containing market demand information relating to at least the healthcare product;
obtaining a second data set containing market availability information relating to at least the healthcare product;
obtaining a third data set containing market consumption information relating to at least the healthcare product;
analyzing data from at least two of the first, second or third data sets to identify a market opportunity for the healthcare product and;
outputting an indication of the market opportunity to a user.

2. A method as defined in claim 1, wherein the market demand information is associated with characteristics of persons having a potential healthcare need associated with the healthcare product.

3. A method as defined in claim 2, wherein the market demand information comprises a likelihood of diagnosis of the potential healthcare need and a likelihood for treatment of the potential healthcare need.

4. (canceled)

5. A method as defined in claim 1, wherein the market availability information is associated with availability of the healthcare product by at least one of healthcare providers, price, payor formularies, location, or consumer groups.

6. A method as defined in claim 5, wherein the availability of the healthcare product is associated with at least one of a provider affiliation characteristic, a provider coverage characteristic, or a payor coverage characteristic.

7. A method as defined in claim 1, wherein the market consumption information is associated with use of at least the healthcare product by persons, wherein the use comprises at least one of pharmacy sales of the healthcare product or prescriptions of the healthcare product.

8. A method as defined in claim 7, wherein the use of the healthcare product is predicted for a second panel from the use of the healthcare product by a first panel.

9. A method as defined in claim 8, wherein the use of the healthcare product is projected to a population of a geographic location based on the predicted use of the product.

10-12. (canceled)

13. A method as defined in claim 1, wherein the market opportunity for the healthcare product comprises at least one of a formulary development strategy, a communication strategy, a healthcare market sizing strategy, a characteristic of patient behavior, a characteristic of healthcare product interaction, a characteristic of healthcare market competition, a healthcare market prioritization strategy, a healthcare marketing return on investment strategy, or a healthcare product forecasting and introduction strategy.

14-15. (canceled)

16. A method as defined in claim 13, wherein the characteristic of the healthcare product interaction comprises an interaction of prescription products and over-the-counter products.

17. A method as defined in claim 13, wherein the healthcare market prioritization strategy is associated with at least one of a manufacturer list price metric, a wholesale price metric, a retail price metric, a pharmacy benefits manager cost metric, a plan cost metric, or a copay cost metric.

18. A computer implemented method for market segmentation, comprising:
obtaining a healthcare data set collected from a plurality of sources;
estimating a provider affiliation characteristic based on claims data;
estimating a provider coverage characteristic based on formulary data;
estimating a payor coverage characteristic based on dispensing records; and
generating a market availability data set from the healthcare data set, the estimated provider affiliation characteristic, the provider coverage characteristic and the payor coverage characteristic.

19. A method as defined in claim 18, wherein obtaining the healthcare data set further comprises:
collecting a consumer panel data set associated with consumer purchase data collected from panelists via a first data collection system;
collecting at least one of formulary information, medical treatment claims information, or pharmacy claims information via a second data collection system;
collecting at least one of a marketing research demographic data set a marketing segmentation data set via a third data collection system; and
collecting a point of sale data set via a fourth data collection system.

20. (canceled)

21. A method as defined in claim 18, wherein generating the market availability data set further comprises:
assembling a matrix with at least two of a drug type dimension, a provider dimension, a payor dimension, a pharmacy dimension or a universe dimension; and
linking at least two of a provider, a prescription, a retailer and a payor with the estimated payor coverage characteristic and the dispensing records.

22. A method as defined in claim 18, wherein the universe dimension comprises geographic regions defined by at least one of a sales territory, a market area, a hospital coverage area, a provider coverage area, a retail service area or a demographic segment area.

23-26. (canceled)

27. A computer implemented method for market segmentation, comprising:
obtaining a healthcare data set collected from a plurality of sources;
analyzing the healthcare data set to determine a patient usage characteristic and a market performance characteristic for a healthcare product;
linking the patient usage characteristic to at least one of the market performance characteristic, a provider characteristic, a retailer characteristic or a payor characteristic according to a geographic location;
predicting a prescription behavior characteristic by analyzing a syndicated panel characteristic and a sufferer panel characteristic;
projecting the predicted prescription behavior characteristic to a population located in a geographic area; and
generating a market consumption data set from the healthcare data set, the patient usage characteristic, the market performance characteristic, the predicted prescription behavior characteristic and the projected behavior characteristic.

28. A method as defined in claim 27, wherein obtaining the healthcare data set comprises
collecting a data set associated with a sufferer panel, wherein the sufferer panel comprises participants undergoing treatment with the healthcare product or possessing a condition treated with the healthcare product;
collecting a consumer panelist data set associated with consumer purchase data collected from panelists via a first data collection system;
collecting a data set including at least one of formulary information, medical treatment claims information, or pharmacy claims information via a second data collection system;
collecting at least one of a marketing research demographic data set or a marketing segmentation data set via a third data collection system; and
collecting a point of sale data set via a fourth data collection system.

29. A method as defined in claim 28, wherein the point of sale data set comprises a dispensation of a prescription or a sale of an over-the-counter product.

30. A method as defined in claim 28, wherein the geographic area is an area defined by an extended zip code.

31. A method as defined in claim 28, wherein analyzing the syndicated panel characteristic and the sufferer panel characteristic further comprises matching an actual treatment usage characteristic and an actual panel measured behavior and attitude characteristic.

32. A method as defined in claim 28, wherein generating the market consumption data set further comprises linking at least two of a measured behavior and attitude data set, a predicted treatment data set, and actual treatment data set, a predicted panel behavior and attitude data set, a projected treatment data set and a projected behavior and attitude data set.

33-90. (canceled)
